(19) United States
(12) Patent Application Publication
(10) Pub. No.: US 2010/0001648 A1
(43) Pub. Date: Jan. 7, 2010

(54) LED LIGHTING THAT HAS CONTINUOUS AND ADJUSTABLE COLOR TEMPERATURE (CT), WHILE MAINTAINING A HIGH CRI

(75) Inventors: John De Clercq, Oordegem (BE); Robbie Thielemans, Nazareth (BE)

Correspondence Address: KNOBBE MARTENS OLSON & BEAR LLP, 2040 MAIN STREET, FOURTEENTH FLOOR, IRVINE, CA, 92614, US

(73) Assignee: Inverto NV, Evergem (BE)

(21) Appl. No.: 12/518,860

(22) PCT Filed: Dec. 12, 2006
(86) PCT No.: PCT/EP2006/011974

§ 371 Date: Jun. 15, 2009

(51) Int. Cl. H01J 13/32; H05B 37/02

(52) U.S. Cl. 315/113; 315/294

(57) ABSTRACT

A modular, standalone, and multi-functional electronic and mechanical platform for light-emitting diode (LED) lighting applications that has continuous and adjustable color temperature (CT) is provided. In particular, a modular LED device is utilized as a standalone lighting device or, alternatively, as a universal and generic building block for forming lighting devices for lighting application. The modular LED device includes an LED circuit, a digital signal processor (DSP), a network interface, and a power supply that can be packaged in a compact, thermally controlled housing. Additionally, the housing can provide alignment and fastening mechanisms for easily coupling one modular LED device to another modular LED device.

### FIELD OF THE INVENTION

The present invention generally relates to the field of illumination devices formed of light-emitting diodes. In particular, the present invention is directed to a modular, standalone, and multi-functional electronic and mechanical platform for light-emitting diode (LED) lighting applications that has continuous and adjustable color temperature (CT) and can maintain a high CRI.

### BACKGROUND

An LED is a semiconductor device that can produce an emission with a brilliant color and high efficiency in spite of its small size. In the past, LEDs have been applied mainly to display devices. For that reason, the use of LEDs as a light source for illumination purposes has not yet been researched and developed sufficiently.

In order to break into the lighting market, it is beneficial to present the market an illumination product that provides compelling motivation for use thereof. In particular, today's LED solutions in the lighting market are very application-specific and/or excessively cumbersome, i.e., too complex mechanically and technically, to compel their general use.

For example, in a typical LED solution, the LEDs therein dictate one or more printed circuit board designs and then the printed circuit board designs dictate the mechanical design. The resulting product is, therefore, limited because its design is suited for one application only, such as for a desk lamp or a ceiling light only. Its design specifications are not suitable for other lighting applications. Alternatively, a generic LED lighting product may be provided that is formed of separate components that require assembly, such as separate electronics, separate power supplies, separate cabling, and a separate control system. Consequently, such a generic design is difficult to sell to a customer because it requires a highly technical understanding thereof, which is overwhelming to the customer. Because it is not understood easily by a non-technical individual (e.g., customer), this generic LED lighting product is not likely to become a standard in the illumination market. For these reasons, a need exists for a generic LED lighting product that provides ease of use for a non-technical individual and that is multi-functional, in order to provide a LED lighting product that is accepted readily into the lighting market and that is suitable for multiple lighting applications.

### BRIEF DESCRIPTION OF THE DRAWINGS

FIG. 1 illustrates a chromaticity diagram;

FIG. 2A illustrates a schematic diagram of a multiple-in-1 (MIO) LED (3-in-1) device in accordance with an embodiment of the invention;

FIG. 2B illustrates a top view of the MIO-LED (3-in-1) device as depicted in FIG. 2A;

FIG. 2C illustrates a cross-sectional view of the MIO-LED (3-in-1) device as depicted in FIG. 2A;

FIG. 3A illustrates a schematic diagram of a MIO-LED (4-in-1) device of another embodiment of the invention.

FIG. 3B illustrates a top view of the MIO-LED (4-in-1) device of as depicted in FIG. 3A; and

FIG. 3C illustrates a cross-sectional view of the MIO-LED (4-in-1) device as depicted in FIG. 3A;

FIG. 4 illustrates a functional block diagram of an LED module system, in accordance with the invention;

FIG. 5 illustrates a perspective front view of a modular LED device, which houses the LED module system of FIG. 4;

FIG. 6 illustrates a perspective back view of the modular LED device, which houses the LED module system of the present invention;

FIGS. 7A and 7B illustrate a first and second perspective view, respectively, of a PCB assembly for forming the LED module system of the present invention;

FIG. 8 illustrates an exploded view of modular LED device, which houses the LED module system of the present invention;

FIG. 9 illustrates a cross-sectional view of modular LED device, which houses the LED module system of the present invention;

FIG. 10 illustrates a front view of a housing/heatsink of the modular LED device that houses the LED module system of the present invention;

FIG. 11 illustrates an exemplary LED configuration of the LED module system of the present invention;

FIG. 12 illustrates a flow diagram of a method of operating the LED module system of the present invention; and

FIG. 13 illustrates an LED circuit for increased efficiency.

FIG. 14 illustrates a configuration of the modular LED device where a secondary coupler provides power thereto via induction.

FIG. 15 shows a configuration where a DC power source provides power to an external primary coupler.

FIG. 17 shows an inductive power supplier; 2010 may incorporate additional circuitry configured to detect the position of the light source in a string.

FIG. 18 shows a common rail that supplies high frequency power directly to a primary coupler.

FIG. 19 shows a common rail that supplies mains power (AC) or DC power indirectly to a primary coupler.

### SUMMARY OF SOME EMBODIMENTS OF INVENTION

One embodiment of the present invention is a Light Emitting Diode, LED, module lighting system (100) comprising:
two or more multiple-in-one, MIO, LED devices (120), each MIO-LED device (120) comprising at least three LEDs (212, 214, 216, 312, 314, 316, 318) together in a housing body (210, 310) wherein:
   a) the light emitting parts of said at least three LEDs are encapsulated in and connected by a solid, transparent material, and
   b) said at least three LEDs (212, 214, 216, 312, 314, 316, 318) each emit a different colour of light, whereby each colour is selected from the group consisting of blue, red, green yellow, orange, cyan, purple, white and magenta,
a digital signal processor, DSP (112), and
a digital to analogue converter, DAC, (124) for each LED (212, 214, 216, 312, 314, 316, 318) or a set of LEDs, wherein the system is configured so that signals from the DSP (112) regulate the overall colour and brightness of light emitted by the MIO-LED devices (120) by controlling the power applied to each LED (212, 214, 216, 312, 314, 316, 318) or set of LEDs through the DAC.

Another embodiment of the present invention is an LED module system (100) as described above, wherein the solid, transparent material comprises at least one phosphor material (228) that is activated by light emitted from one or more of said LEDs, so producing light having a spectrum broader than that emitted by said activating LED.

Another embodiment of the present invention is an LED module system (100) as described above, wherein the phosphor material (228) comprises one or more of the phosphors listed in Tables 1, 2 or 3, or an optical brighteners.

Another embodiment of the present invention is an LED module system (100) as described above, wherein:
at least one LED in a MIO-LED (120) device emits blue light, and
phosphor material (228) is yttrium-aluminum-garnet, YAG, phosphor.

Another embodiment of the present invention is an LED module system (100) as described above, wherein said DSP (112) is configured to control the power applied to each LED (212, 214, 216, 312, 314, 316, 318) or set of LEDs, such that the colour and brightness of light emitted is the same for each MIO-LED device (120).

Another embodiment of the present invention is an LED module system (100) as described above, further comprising a pulse width modulator, PWM, switch (126) for controlling the power applied to each LED (212, 214, 216, 312, 314, 316, 318) or a set of LEDs, using signals from the DSP (112).

Another embodiment of the present invention is an LED module system (100) as described above, wherein the DSP is configured to control the PWM switch (126) to adjust the power supplied to two or more LEDs of the same colour present in separate MIO-LED devices (120), when said two or more LEDs emit different shades of said colour.

Another embodiment of the present invention is an LED module system (100) as described above, wherein the DSP is configured to control the DAC to adjust the power supplied to two or more LEDs of the same colour present in separate MIO-LED devices (120), when said two or more LEDs emit different shades of said colour.

Another embodiment of the present invention is an LED module system (100) as described above, wherein said two or more LEDs of the same colour have not been grouped by binning.

Another embodiment of the present invention is an LED module system (100) as described above, further comprising one or more temperature sensors (130) configured to provide temperature information of the module to the DSP (112).

Another embodiment of the present invention is an LED module system (100) as described above, wherein the DSP (112) is configured to control of the power applied to each LED (212, 214, 216, 312, 314, 316, 318) or set of LEDs of an MIO-LED device (120) based on temperature information received from the temperature sensors (130), such that the colour and brightness of light emitted from each MIO-LED device (120) is maintained where there are changes in temperature.

Another embodiment of the present invention is an LED module system (100) as described above, further comprising one or more air cooling fan (260), configured to cool at least some of the LEDs (212, 214, 216, 312, 314, 316, 318).

Another embodiment of the present invention is an LED module system (100) as described above, wherein said DSP (112) is configured to control power to the fan (260) based on temperature information received from the temperature sensors (130). Another embodiment of the present invention is an LED module system (100) as described above, wherein the DSP (112) is configured, such that the colour and brightness of light emitted from each MIO-LED device (120) is maintained where there are changes in temperature.

Another embodiment of the present invention is an LED module system (100) as described above, further comprising one or more network interfaces (114) configured to signals to the DSP (112), allowing an external control.

Another embodiment of the present invention is an LED module system (100) as described above, further comprising one or more IR sensors (114) configured provide to signals to the DSP (112), allowing an external control.

Another embodiment of the present invention is an LED module system (100) as described above, further comprising a power supply (116) configured to supply power to the LEDs (212, 214, 216, 312, 314, 316, 318) and other components.

Another embodiment of the present invention is an LED module system (100) as described above, wherein said power supply (116) has a plurality of DC voltage outputs, each providing a different voltage to match the rating voltage for a colour-emitting LED (212,214, 216, 312,314, 316, 318).

Another embodiment of the present invention is an LED module system (100) as described above, wherein said power supply (116) is configured to adapt it's output level, for at least one colour dependent, on the required light output, controlled by the DSP.

Another embodiment of the present invention is an LED module system (100) as described above, further comprising a secondary induction coupler (2005), which provides power to the power supply (116) by electromagnetic induction from a primary induction coupler (2006).

Another embodiment of the present invention is an LED module system (100) as described above, further comprising a memory storage device (128) configured to provide data to the DSP (112) regarding colour and/or brightness compensation information of each MIO-LED device (120).

Another embodiment of the present invention is an LED module system (100) as described above, wherein the DSP (112) is configured to continuously monitor the power supplied to each LED (212, 214, 216) in order to maintain the colour and brightness provided by each MIO-LED device (120).

Another embodiment of the present invention is an LED module system (100) as described above, wherein the colour and brightness are maintained according to relationships between current and colour behavior, and/or light output vs. temperature data.

Another embodiment of the present invention is an LED module system (100) as described above, wherein said relationships are stored as data within storage device (128) where present.

Another embodiment of the present invention is an LED module system (100) as described above, wherein the colour temperature, CT, of the emitted light is adjustable.

Another embodiment of the present invention is an LED module system (100) as described above, capable of emitting light that provides a high colour rendition index, CRI.

Another embodiment of the present invention is a modular LED device (201) comprising a housing and one or more LED module systems (100) as described above, whereby:
an array of MIO-LED devices (120) is arranged as a light emitting surface
a mechanical means to stack two or more modular LED devices (201) is provided.

Another embodiment of the present invention is a modular LED device (201) as described above, whereby said mechanical stacking means aligns the respective light emitting surfaces to project light towards the same direction.

Another embodiment of the present invention is a modular LED device (201) as described above, wherein the housing comprises an interfacing material which can be used to make contact with other heat conductive materials, so as to transfer heat from the device more easily.

### DETAILED DESCRIPTION OF THE INVENTION

Unless defined otherwise, all technical and scientific terms Used herein have the same meaning as is commonly understood by one of skill in the art. All publications referenced herein are incorporated by reference thereto. All United States patents and patent applications referenced herein are incorporated by reference herein in their entirety including the drawings.

The articles “a” and “an” are used herein to refer to one or to more than one, i.e. to at least one of the grammatical object of the article. By way of example, “a cooling fan” means one cooling fan or more than one cooling fan.

Throughout this application, the term “about” is used to indicate that a value includes the standard deviation of error for the device or method being employed to determine the value.

The recitation of numerical ranges by endpoints includes all integer numbers and, where appropriate, fractions subsumed within that range (e.g. 1 to 5 can include 1, 2, 3, 4 when referring to, for example, a number of cooling fans, and can also include 1.5, 2, 2.75 and 3.80, when referring to, for example, measurements). The recitation of end points also includes the end point values themselves (e.g. from 1.0 to 5.0 includes both 1.0 and 5.0)

The present invention relates to a generic LED lighting product that provides ease of use for a non-technical individual and that is multi-functional and suitable for multiple lighting applications. In particular, a modular LED device of the present invention may be utilized as a standalone lighting device. Alternatively, the modular LED device of the present invention may be utilized as a universal and generic building block for forming lighting devices for any lighting application. In particular, a lighting device may be formed of an easily configured arrangement of multiple modular LED devices of the present invention.

Reference is made in the description below to the drawings which exemplify particular embodiments of the invention; they are not at all intended to be limiting. The skilled person may adapt the device and substituent components and features according to the common practices of the person skilled in the art.

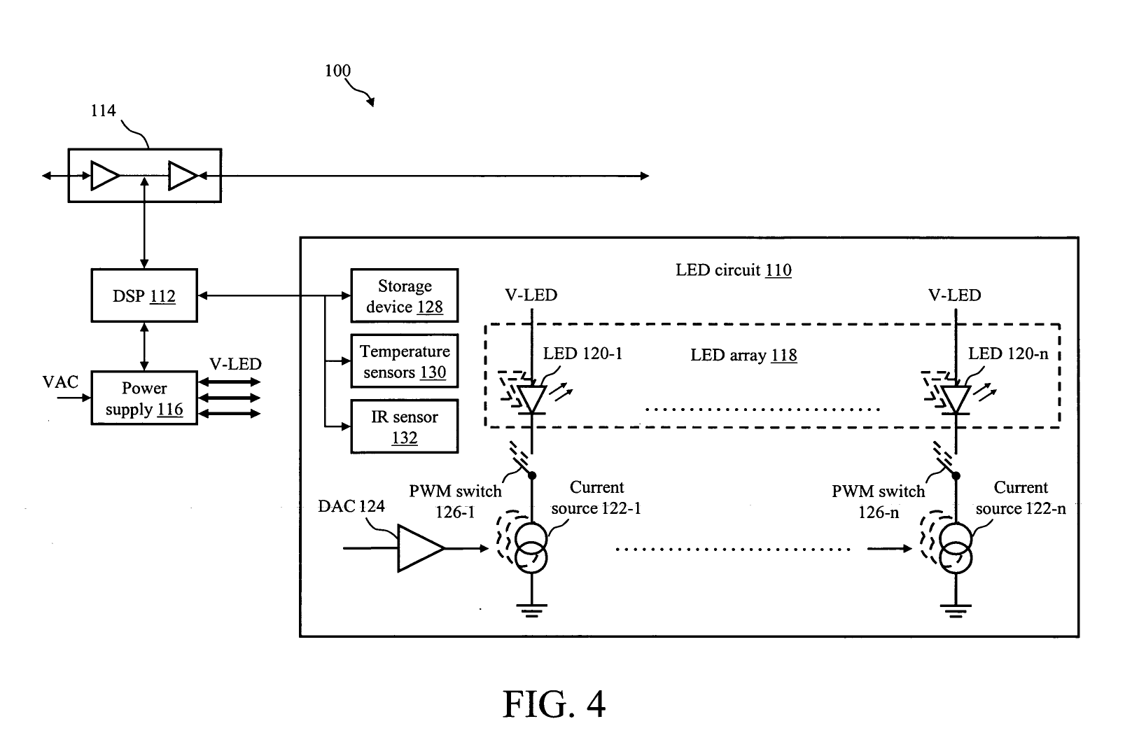

FIG. 4 illustrates a functional block diagram of an LED module system 100, in accordance with the invention. LED module system 100 is the electrical design of a modular LED device that provides a generic building block that is easy to use and suitable for multiple lighting applications. LED module system 100 preferably includes an LED circuit 110, a digital signal processor (DSP) 112, a network interface 114, and a power supply 116. LED circuit 110 further includes an LED array 118 that is formed of a plurality of “multiple-in-one”-LED (MIO-LED) devices 120 (e.g., MIO-LED devices 120-1 to 120-n), a plurality of current sources 122 (e.g., current sources 122-1 to 122-n), at least one digital-to-analog converter (DAC) 124, a plurality of pulse-width modulation (PWM) switches 126 (e.g., PWM switches 126-1 to 126-n), at least one storage device 128, one or more temperature sensors 130, and an infrared (IR) sensor 132. A suggested configuration connecting the components of LED module system 100 is shown in FIG. 4.

LED array 118 of LED circuit 110 may be any array configuration of LED devices, such as an array of MIO-LED devices 120. Example LED configurations include, but are not limited to, 15×3, 16×4, 17×4, 17×5, and 18×5 arrays.

### Multiple-In-One-LED Device (MIO-LED Devices)

Each MIO-LED device 120 (e.g., each MIO-LED device 120-1 through 120-n) of LED array 118 may comprise a multitude of LEDs i.e. it may be a ‘multiple-in-one’ LED-device (MIO-LED). A MIO-LED device, is a device having a number of LEDs in one housing body e.g. 3 LEDs (3-in-1), 4 LEDs (4-in-1), 5 LEDs (5-in-1), 6 LEDs (6-in-1), 7 or more LEDs etc. Of the LEDs present in a MIO-LED device, any three of them each may emit a different colour of light, whereby each colour is selected from the group consisting of blue, red, green yellow, orange, cyan, purple, white and magenta,

The LEDs used in the present invention can be any kind of LED known in the art, capable of providing light at the required wavelength or within a defined band of wavelengths. LEDs typically comprise semiconducting material impregnated, or doped, with impurities to create a p-n junction. Such LEDs behave like diodes insofar as current flows from the p-side, or anode, to the n-side, or cathode, but not in the other direction. The wavelength of light emitted, depends on the band gap energy of the materials forming the p-n junction. Where the semiconducting material is an inorganic substance or mixture, it can be any suitable for the wavelength required e.g. aluminum gallium phosphide (AlGaP) for green light or gallium phosphide (GaP) for red, yellow or green light, zinc selenide (ZnSe) for blue light. Such combination of semiconducting materials are known in the art. Where the semiconducting material is an organic substance or mixture (i.e. producing an OLED), it can be any suitable for the wavelength required. Such organic substances are known in the art. The term LED used herein covers light emitting semiconductors which are formed of inorganic or organic materials.

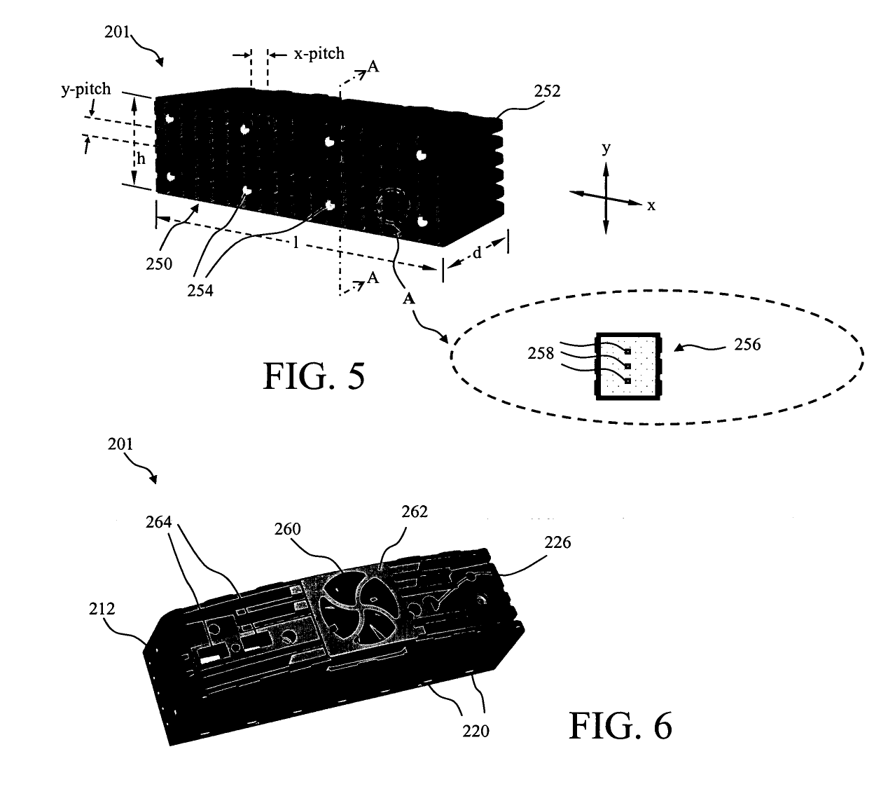

Generally, the quality of white light produced by light sources for illumination purposes is expressed in terms of a colour rendition index (CRI) value. More specifically, light sources, such as LEDs, of the same color can vary widely in the quality of light that is emitted. One light source may have a continuous spectrum, while the other light source emits light in a few narrow bands only of the spectrum. Therefore, a useful way to determine the quality of a light source is its CRI, which serves as a quality distinction between light sources emitting light of the same color. The highest CRI attainable is 100. CRI is a method of describing the effect of a light source on the color appearance of objects, compared with a reference light source of the same color temperature. Additionally, CT is a simplified way to characterize the spectral properties of a light source. Low CT implies warmer (more yellow/red) light, while high CT implies a colder (more blue) light. The standard unit for color temperature is Kelvin (K). For example, daylight has a rather low CT near dawn (approximately 3200K) and a higher CT around noon (approximately 5500K). With this in mind, the use of the MIO-LED devices 120 in an LED array 118 provides a LED module system 100 and associated modular LED devices (FIGS. 5 through 10) with a continuous, uniform, and adjustable CT range (e.g., 3200 K to 9500 K) while maintaining a high CRI (e.g., 90 or greater) for lighting applications.

The MIO-LED device has high CRI values for lighting applications, such as, for example, overhead lighting in a room or outdoor area lighting. Because a light source emits radiant energy that is relatively balanced in all visible wavelengths will appear white to the eye, the LED devices of the present invention provide multiple LEDs e.g., red, green and blue, in one package, which allows color mixing in order to provide an appropriate white light source for illumination purposes that, additionally, has the ability to provide CT tracking.

In particular, the MIO-LED devices of the present invention may utilize at least one phosphor material for converting coloured light (e.g. red, green blue) into broader spectrum light, such as, for example, white light. A phosphor material is any material that is activated by light (e.g. blue, ultraviolet, red, green) produced by an LED, so producing broader spectrum light, such as, for example, white light. Broader spectrum light, is light which has a wider bandwidth compared with the activating light i.e. the LED. Preferably a blue LED is provided in combination with phosphor material for producing white light.

The phosphor material may be disposed over the other LEDs of the MIO-LED device; in doing so, it provides a mechanism for diffusing the light emitted by the LED, which renders the LED a surface-emitter rather than a point-emitter device and is, thus, more suited for general illumination purposes. The phosphor material need not be limited to the LED, but can be disposed over any transparent part of any casing or housing. Furthermore, the MIO-LED devices of the present invention have a high CRI (e.g., >90) over a continuous, uniform, and adjustable CT range of, for example, 3200 K to 9500 K.

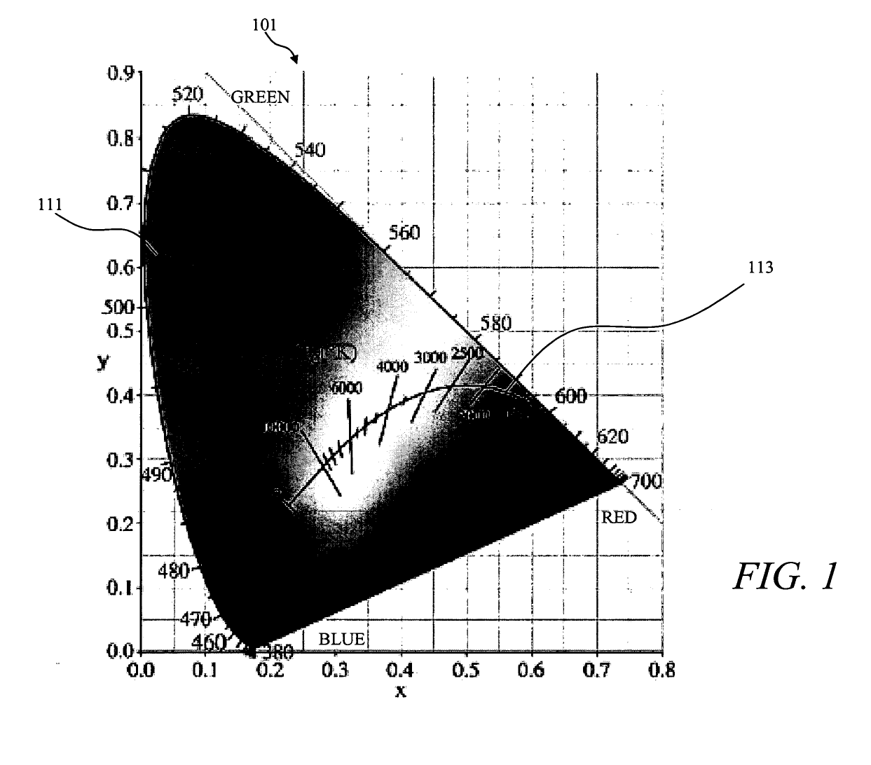

FIG. 1 illustrates a chromaticity diagram 101, which is provided as a reference for the discussion to follow with regard to the MIO-LED devices of the present invention. As is well known, a chromaticity diagram, such as chromaticity diagram 101, is a triangular-shaped line that connects the chromaticities of the spectrum of colors. In the case of chromaticity diagram 101, this line defines a color triangle 111. The curved line within color triangle 111 of chromaticity diagram 101 shows where the color of the spectrum lie and is called the spectral locus. In particular, a black body curve 113 is the spectral locus for white light. Combinations of colors, such as shades of blue, green, yellow, orange, and red, along black body curve 113 mix and produce white light. The colour temperatures along black body curve 113 are indicated in Kelvin. Furthermore, FIG. 1 shows the range of CTs along the length of black body curve 113. For example, the end of black body curve 113 that is near the blue area indicates a CT of 10000K (cool light) and approaches infinity. By contrast, the end of black body curve 113 that is near the red area indicates a CT of 2500K (warm light) and approaches zero. Additionally, those skilled in the art will understand that the more colors of the spectrum that are present with sufficiently high energy levels within a white light source, the higher the CRI of the white light source and, thus, the higher the quality of the white light.

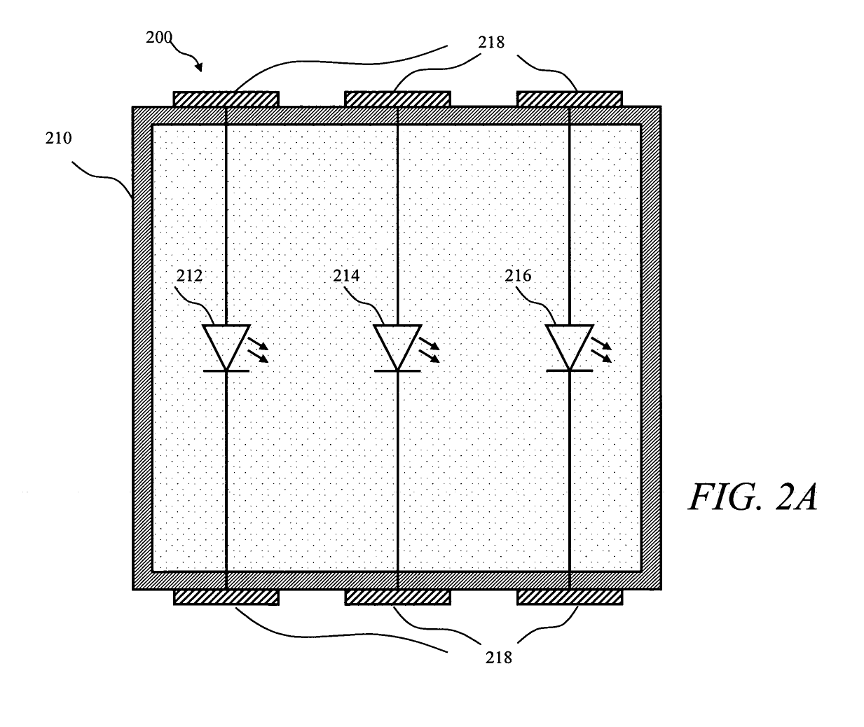

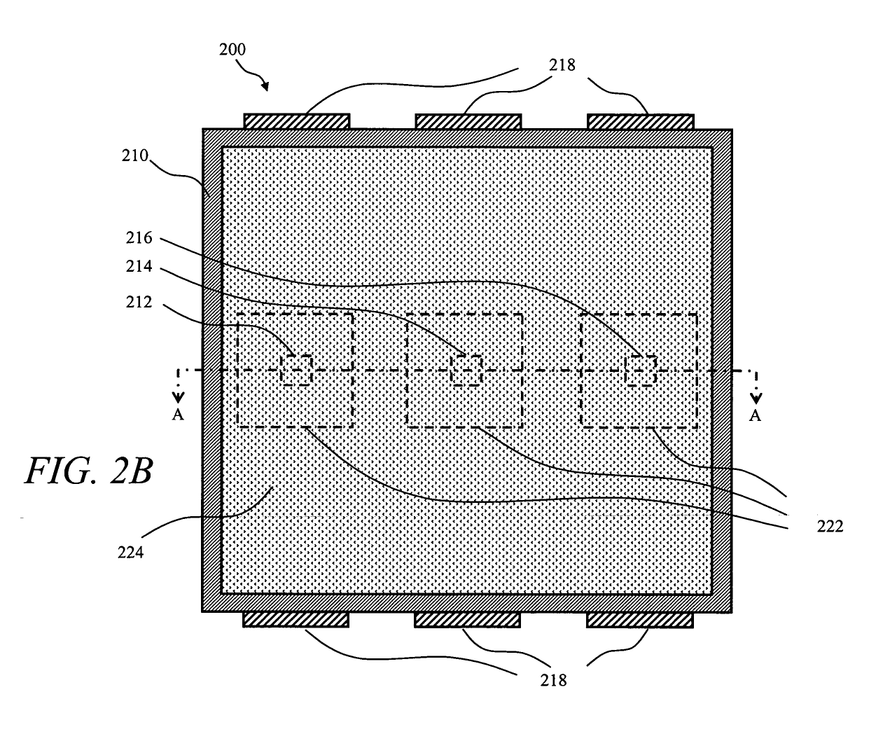

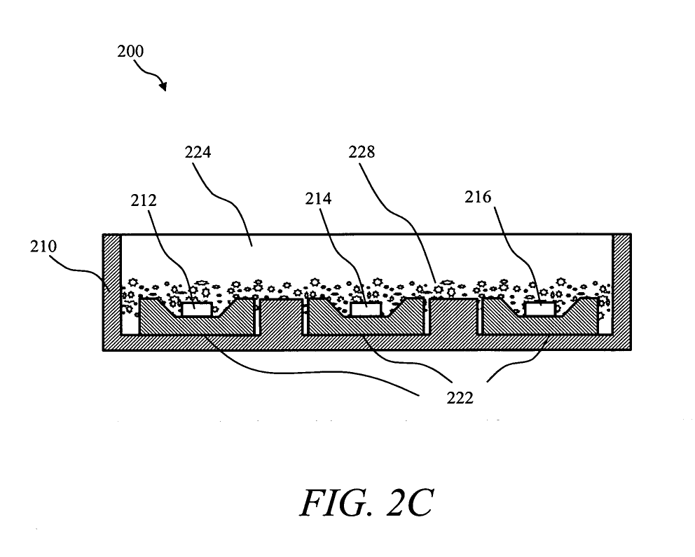

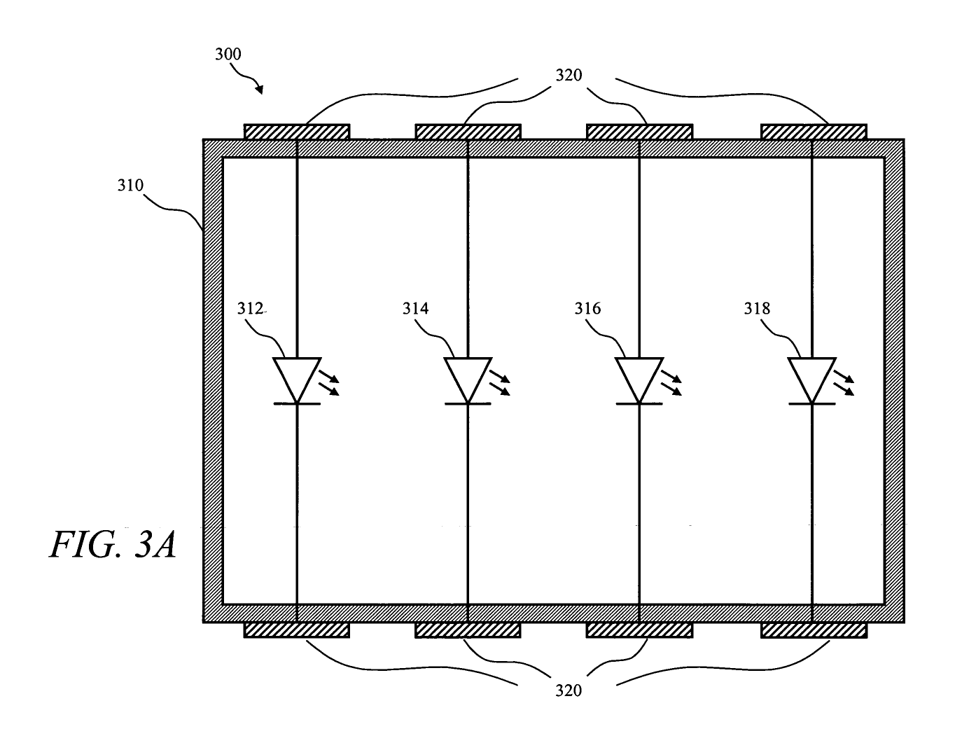

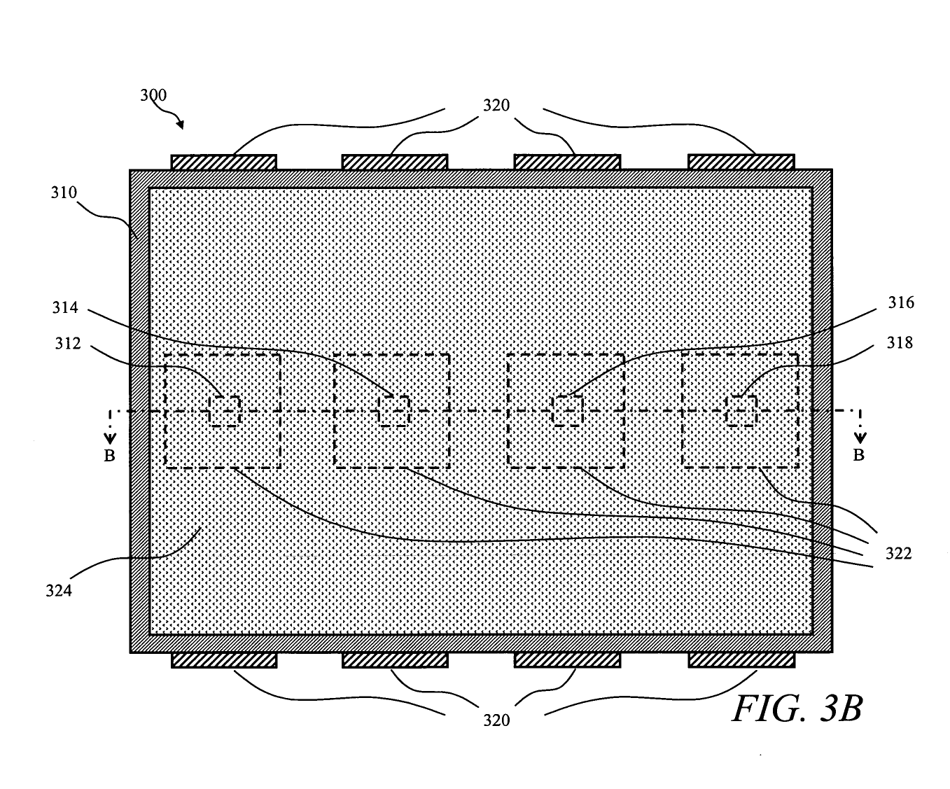

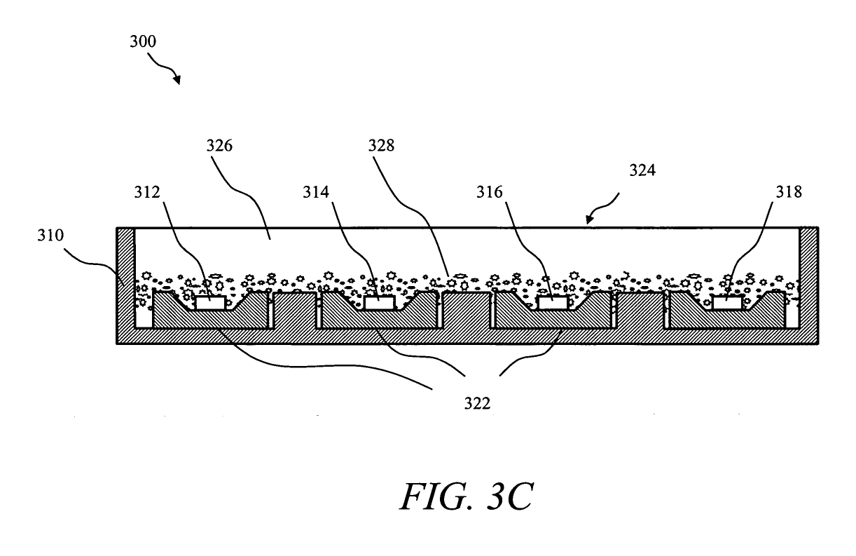

According to one aspect of the invention, a MIO-LED device comprises three or more LEDs 212, 214, 216, 312, 314, 316, 318 (FIGS. 2A to 3C) together in a housing body 210, 310 wherein
a) the light emitting parts of at least three LEDs are encapsulated in and connected by a solid, transparent material,
c) said at least three LEDs (212, 214, 216, 312, 314, 316, 318) each emit a different colour of light, whereby each colour is selected from the group consisting of blue, red, green yellow, orange, cyan, purple, white and magenta.

The solid, transparent material may comprise a rigid material or may comprise a non-rigid material (e.g. with gel-like properties). Examples of suitable solid, transparent materials include, for example, epoxy and silicon. The solid transparent material may enclose the light emitting parts; this may mean that all the light emitted passes through the solid transparent material, and no light may escape elsewhere. The solid transparent material may connect the light emitting parts; this may mean that the light emitting parts contact a common, continuous, solid transparent material.

The solid transparent material may be blended with a quantity of phosphor material 228 which comprises one or more phosphors activated by light emitted from one or more of the encapsulated LEDs, so producing light which has a wider spectrum compared with the activating light i.e. the LED, as mentioned above. Examples of suitable phosphor material 228 include yttrium-aluminum-garnet phosphor (YAG-phosphor) which is activated by blue light.

Examples of phosphors which may be present in a phosphor material 228 include, but are not limited to any indicated in Tables 1, 2 or 3 compounds, where the colour of light emitted is also given in brackets. Phosphors may be blended so as to give the necessary broad emission spectrum.

TABLE 1
Phosphor materials useful according to the invention

ZnS: Ag + (Zn,Cd)S: Ag (P4) (white), Y₂O₂S: Eu + Fe₂O₃ (P22R) (red), ZnS: Cu,Al (P22G)
(green), ZnS: Ag + Co-on-Al₂O₃ (P22B) (blue), Zn₂SiO₄: Mn (P1, GJ), (yellowish-green (525
nm)), ZnS: Ag,Cl or ZnS: Zn (P11, BE), (blue (460 nm)), (KF,MgF₂): Mn (P19, LF) (yellow
(590 nm)), (KF,MgF₂): Mn (P26, LC), (orange (595 nm)), (Zn,Cd)S: Ag or (Zn,Cd)S: Cu
(P20, KA), (yellow-green), ZnO: Zn (P24, GE) (green (505 nm)), (Zn,Cd)S: Cu,Cl (P28, KE)
(yellow), ZnS: Cu or ZnS: Cu,Ag (P31, GH), y(ellowish-green), MgF₂: Mn (P33, LD) (orange
(590 nm)), (Zn,Mg)F₂: Mn (P38, LK), (orange (590 nm)) Zn₂SiO₄: Mn,As (P39, GR) (green
(525 nm)), ZnS: Ag + (Zn,Cd)S: Cu (P40, GA) (white), Gd₂O₂S: Tb (P43, GY) (yellow-green
(545 nm)), Y₂O₂S: Tb (P45, WB), (white (545 nm)), Y₂O₂S: Tb, (green (545 nm)),
Y₃Al₅O₁₂: Ce (P46, KG) (green (530 nm)), Y₃(Al,Ga)₅O₁₂: Ce (green (520 nm)), Y₂SiO₅: Ce
(P47, BH) (blue (400 nm)), Y₃Al₅O₁₂: Tb (P53, KJ) (yellow-green (544 nm)),
Y₃(Al,Ga)₅O₁₂: Tb (yellow-green (544 nm)), ZnS: Ag,Al (P55, BM) (blue (450 nm)), InBO₃: Tb
(yellow-green (550 nm)), InBO₃: Eu (yellow (588 nm)), ZnS: Ag (blue (450 nm)), ZnS: Cu,Al
or ZnS: Cu,Au,Al (green (530 nm)), Y₂SiO₅: Tb (green (545 nm)),
(Zn,Cd)S: Cu,Cl + (Zn,Cd)S: Ag,Cl (white), InBO₃: Tb + InBO₃: Eu (amber),
(ZnS: Ag + ZnS: Cu + Y₂O₂S: Eu (white), InBO₃: Tb + InBO₃: Eu + ZnS: Ag (white)

TABLE 2
Phosphor materials useful according to the invention.

(Ba,Eu)Mg₂Al₁₆O₂₇ (blue), (Ce,Tb)MgAl₁₁O₁₉ (green), (Y,Eu)₂O₃(red),
(Sr,Eu,Ba,Ca)₅(PO₄)₃Cl (blue), (La,Ce,Tb)PO₄ (green), Y₂O₃: Eu (red (611 nm)),
LaPO₄: Ce,Tb (green (544 nm)), (Sr,Ca,Ba)₁₀(PO₄)₆Cl₂: Eu (blue (453 nm)),
BaMgAl₁₀O₁₇: Eu,Mn (blue-green (456/514 nm)), (La,Ce,Tb)PO₄: Ce,Tb (green (546 nm)),
Zn₂SiO₄: Mn (green (528 nm)), Zn₂SiO₄: Mn,Sb₂O₃(green (528 nm)),
Ce_{0.67}Tb_{0.33}MgAl₁₁O₁₉: Ce,Tb (green (543 nm)), Y₂O₃: Eu(III) (red (611 nm)),
Mg₄(F)GeO₆: Mn ((red (658 nm)), Mg₄(F)(Ge,Sn)O₆: Mn (red (658 nm)), MgWO₄ (pale blue
(473 nm)), CaWO₄ (blue (417 nm)), CaWO₄: Pb (scheelite, blue (433 nm)), (Ba,Ti)₂P₂O₇: Ti
(blue-green (494 nm)), Sr₂P₂O₇: Sn, blue (460 nm), Ca₅F(PO₄)₃: Sb (blue (482 nm)),
Sr₅F(PO₄)₃: Sb,Mn (blue-green (509 nm)), BaMgAl₁₀O₁₇: Eu,Mn (blue (450 nm)),
BaMg₂Al₁₆O₂₇: Eu(II) (blue (452 nm)), BaMg₂Al₁₆O₂₇: Eu(II),Mn(II) (blue (450 + 515 nm)),
Sr₅Cl(PO₄)₃: Eu(II) (blue (447 nm)), Sr₆P₅BO₂₀: Eu (blue-green (480 nm)),
(Ca,Zn,Mg)₃(PO₄)₂: Sn (orange-pink (610 nm)), (Sr,Mg)₃(PO₄)₂: Sn (orange-pinkish white
(626 nm)), CaSiO₃: Pb,Mn (orange-pink (615 nm)), Ca₅F(PO₄)₃: Sb,Mn (yellow),
Ca₅(F,Cl)(PO₄)₃: Sb,Mn (warm white to cool white or blue or daylight),
(Ca,Sr,Ba)₃(PO₄)₂Cl₂: Eu (blue (452 nm)), 3 Sr₃(PO₄)₂•SrF₂: Sb,Mn (blue (502 nm)),
Y(P,V)O₄: Eu (orange-red (619 nm)), (Zn,Sr)₃(PO₄)2: Mn (orange-red (625 nm)), Y₂O₂S: Eu
(red (626 nm)), (Sr,Mg)₃(PO₄)₂: Sn(II) (orange-red (630 nm)), 3.5 MgO•0.5 MgF₂•
GeO₂: Mn (red (655 nm)), Mg₅As₂O₁₁: Mn (red (660 nm)), Ca₃(PO₄)₂•CaF₂: Ce,Mn, (yellow
(568 nm)), SrAl₂O₇: Pb (ultraviolet (313 nm)), BaSi₂O₅: Pb (ultraviolet (355 nm)),
SrFB₂O₃: Eu(II) (ultraviolet (366 nm)), SrB₄O₇: Eu (ultraviolet (368 nm)), MgGa₂O₄: Mn(II),
(blue-green), (Ce,Tb)MgAl₁₁O₁₉ (green).

TABLE 3
Phosphor materials useful according to the invention.

Gd₂O₂S: Tb (P43) (green (peak at 545 nm)), Gd₂O₂S: Eu (red (627 nm)), Gd₂O₂S: Pr (green
(513 nm)), Gd₂O₂S: Pr,Ce,F (green (513 nm)), Y₂O₂S: Tb (P45) (white (545 nm)), Y₂O₂S: Tb
(P22R) (red (627 nm)), Y₂O₂S: Tb (white (513 nm)), Zn(0.5)Cd(0.4)S: Ag (HS) (green (560
nm)), Zn(0.4)Cd(0.6)S: Ag (HSr) (red (630 nm)), CdWO₄ (blue (475 nm)), CaWO₄ (blue
(410 nm)), MgWO₄ (white (500 nm)), Y₂SiO₅: Ce (P47) (blue (400 nm)), YAlO₃: Ce (YAP)
(blue (370 nm)), Y₃Al₅O₁₂: Ce (YAG) (green (550 nm)), Y₃(Al,Ga)₅O₁₂: Ce (YGG) (green
(530 nm)), CdS: In (green (525 nm)), ZnO: Ga (blue (390 nm)), ZnO: Zn (P15) (blue (495
nm)), (Zn,Cd)S: Cu,Al (P22G) (green (565 nm)), ZnS: Cu,Al,Au (P22G) (green (540 nm)),
ZnCdS: Ag,Cu (P20) (green (530 nm)), ZnS: Ag (P11) (blue (455 nm)), anthracene (blue
(447 nm)), plastic (EJ-212, blue (400 nm)), Zn₂SiO₄: Mn (P1) (green (530 nm)), ZnS: Cu
(GS) (green (520 nm)), CsI: Tl (green (545 nm)), ⁶LiF/ZnS: Ag (ND) (blue (455 nm)),
⁶LiF/ZnS: Cu,Al,Au (NDg) (green (565 nm)).

Examples of other phosphors include, but are not limited to optical brighteners, which act act as UV-sensitive phosphors with close-to-zero afterglow. Usually they are organic compounds, typically found in detergents. In order to obtain a broader emission spectrum and the desired colours, the above mentioned phosphors may be mixed according to the practices of the skilled person.

Thus, the arrangement of a MIO-LED that includes phosphor material 228 allows the production of white light by virtue of the interaction between the phosphor and the activating LEDs (e.g. blue emitting LED). The inventors have also found, it also allows adjustment of the CT by virtue of the non-activating LEDs present (e.g. red or yellow when the phosphor is YAG-phosphor). Furthermore, the phosphor has an efficient diffusing effect on the light output, meaning the light is mixed at very close distance; the consequence is a higher CRI compared with separate, non-diffused LEDs.

A further advantage is that the non-activating LEDs can be used to adjust minor differences in CT between any two MIO-LED devices; the consequence is that binning (the practice by manufacturers of testing each LED for flux, colour, voltage and placing each in a bin for given tolerances) can be eliminated.

According to one aspect of the invention, the paths of light emitted by said at least three LEDs (212, 214, 216, 312, 314, 316, 318) at least partly overlap. This requires the said LEDs to be in close proximity to eachother. Preferably, the LEDs are arranged so their paths of light overlap, such that their individual colours are blended when the activated MIO-LED viewed at a distance of no less than 50 mm. This viewing distance may be reduced to no less than 5 mm when the diffusing phosphor is present.

### 3 in 1 Embodiment of a MIO-LED Device

FIG. 2A illustrates a schematic diagram of a MIO-LED (3-in-1) device 200 in accordance with an embodiment of the invention. LED (3-in-1) device 200 includes a device housing body 210 within which is arranged three LEDs 212, 214, 216. The housing body 210 positions the LEDs so the paths of light emitted thereby at least partly overlap. It also provide an appropriate projection direction for the paths of light. 3-in-1 LED device 200 further includes a plurality of leads 218 that are arranged on the perimeter of device housing body 210. More specifically, the cathode and anode of LED 212 is electrically connected to a first pair of leads 218, respectively; the cathode and anode of LED 214 is electrically connected to a second pair of leads 218, respectively; the cathode and anode of LED 216 is electrically connected to a third pair of leads 218, respectively; as shown in FIG. 2A.

FIG. 2B illustrates a top view (not to scale) of MIO-LED (3-in-1) device 200 of an embodiment of the invention. FIG. 2C illustrates a cross-sectional view (not to scale) of MIO-LED (3-in-1) device 200, taken along line A-A of FIG. 1B. FIGS. 2B and 2C show that LEDs 212, 214, and 216 of MIO-LED (3-in-1) device 200 are arranged physically in a cavity formed by the sidewalls and floor of housing body 210. In particular, LEDs 212, 214, and 216 are mounted on respective pedestals 222 that are arranged within housing body 210, as shown in FIGS. 2B and 2C. Additionally, LEDs 212, 214, and 216 are encapsulated within housing body 210 of 3-in-1 LED device 200 by use of a solid, transparent material 224, which material encloses and connects the light emitting parts.

With continuing reference to FIGS. 2A, 2B, and 2C, MIO-LED (3-in-1) device 200 is formed by a 1×3 array of LEDs. Housing body 210 may be formed of any suitably rigid, lightweight, thermally-conductive, and electrically non-conductive material, such as, but not limited to, molded plastic or ceramic. Housing body 210 provides a cavity within which LEDs 212, 214, and 216 are mounted. The cavity may be formed by a set of sidewalls and a floor, as shown in FIGS. 2B and 2C. The length, width, and height of housing body 210 may vary. An example length, width, and height may be 5.5×5.5×2.5 millimeters (mm), respectively. Leads 218 are formed of electrically conductive material, such as, but not limited to, a gold plated copper alloy. Leads 218 may be any standard lead structure, such as a surface-mount type lead. On a given side of housing body 210, the spacing between leads 218 may be, for example, 1.78 mm.

LED 212, LED 214, and LED 216 may be standard LED die devices of various application- or user-defined color combinations that produce white light. In particular, the combination of the individual colors emitted by LED 212, LED 214, and LED 216, respectively, mix to produce a white light and, thereby, render 3-in-1 LED device 200 a white illumination device. In a preferred embodiment, at least one of LED 212, LED 214, and LED 216 is a blue LED, while the color of the remaining two LEDs may be vary (e.g., various combinations of red, green, blue, yellow, orange, cyan, and/or magenta). The placement of the blue LED within the arrangement of LED 212, LED 214, and LED 216 is normally inconsequential e.g. it may be flanked by LED of other colours, or may flank one of the other LEDs. In one example, LED 212 is a red LED, LED 214 is a blue LED, and LED 216 is a green LED. In another example, LED 212 is a yellow LED, LED 214 is a blue LED, and LED 216 is a cyan LED. 3-in-1 LED device 200 is not limited to the examples cited above, other color combinations are possible.

LED 212, LED 214, and LED 216 may each be mounted on a pedestal 222, respectively, which reside within a cavity formed by housing body 210. Each pedestal 222 is formed of an electrically conductive material, such as, but not limited to, copper, aluminum, silver, or gold. By use of each pedestal 222, electrically conductive wires (not shown) are bonded between the anode and cathode of each LED and its respective pair of leads 218 and, thus, an electrical connection is formed therebetween, as shown in FIG. 2A. Pedestals 222 and, thus, LED 212, LED 214, and LED 216 may be placed on a pitch of, for example, 0.95 mm.

LED 212, LED 214, and LED 216 are encapsulated within housing body 210 by use of solid, transparent material 224, which material encloses and connects the light emitting parts. The solid, transparent material 224 may comprise, for example, a transparent epoxy. The epoxy may be blended with and a quantity of phosphor material 228 (e.g., YAG-phosphor). The combination of phosphor material with a blue LED produces a high-brightness white light source. Epoxy, into which YAG-phosphor is blended, may be a transparent epoxy resin. Additionally, the percent of YAG-phosphor that is present within solid, transparent material 224 may be, for example, between 0 and 5%. One example manufacturer of high-brightness while LEDs by use of YAG-phosphor in combination with a blue LED is Nichia Corporation (Japan). YAG is commonly used as the down-conversion phosphor in white LEDs, as YAG phosphor can be excited by the radiation from blue LEDs, which produces white light. An example supplier of powder phosphors consisting of micron- or submicron-size particles is Nitto Denko Technical Corporation (Carlsbad, Calif.). Furthermore, another benefit of the presence of the phosphor material 228 (e.g., YAG-phosphor) within the solid, transparent material 224 is that the phosphor material 228 acts to diffuse the light that is emitted by LED 212, LED 214, and LED 216. As a result, 3-in-1 LED device 200 is converted from a point-emitting light source to a surface-emitting light source, which is more suited for functional lighting applications.

With continuing reference to FIGS. 2A, 2B, and 2C, various combinations of colored LEDs within MIO-LED (3-in-1) device 200 for producing a white light source that is suitable for functional lighting applications are disclosed, e.g., red (R), green (G), blue (B), yellow (Y), orange (O), cyan (C), purple (P) and/or magenta (M). In each case, 3-in-1 LED device 200 may include at least one blue LED that reacts with the YAG (i.e., B+YAG) to produce white light. In the case wherein 3-in-1 LED device 200 includes R, G, and B+YAG, the combination thereof provides the mechanism by which the CT (see FIG. 1) may be determined and adjusted, as compared with standard light sources. The addition of R and G provides a shift along black body curve 112 of chromaticity diagram 100 of FIG. 1 further toward the blue area, as compared with an LED with B+YAG alone. Furthermore, by varying the current that is supplied to LED 212, LED 214, and LED 216, the colors of the LEDs may change slightly, which then has a positive effect on producing a higher CRI. In another example configuration, MIO-LED (3-in-1) device 200 may include Y, P, and B+YAG, to produce white light and to provide yet a further shift along black body curve 112 toward the blue area, as compared with B+YAG alone or R, G, and B+YAG. In yet another example configuration, 3-in-1 LED device 200 may include Y, C, and B+YAG to produce a device with a yet higher CRI because this combination adds even more spectra to the light.

In all instances of MIO-LED (3-in-1) device 200, adding two colors, such as R and G, to B+YAG adds more light spectra, which increases the CRI and, thus, increases the light quality.

### 4 in 1 Embodiment of a MIO-LED Device

FIG. 3A illustrates a schematic diagram of a MIO-LED (4-in-1) device 300 of a second embodiment of the invention. MIO-LED (4-in-1) device 300 includes a housing body 310 within which is arranged four LEDs 312, 314, 316, 318. MIO-LED (4-in-1) device 300 further includes a plurality of leads 320 that are arranged on the perimeter of housing body 310. More specifically, the cathode and anode of LED 312 may be electrically connected to a first pair of leads 320, respectively; the cathode and anode of LED 314 may be electrically connected to a second pair of leads 320, respectively; the cathode and anode of LED 316 may be electrically connected to a third pair of leads 320, respectively; the cathode and anode of LED 318 may be electrically connected to a fourth pair of leads 320, respectively; as shown in FIG. 3A.

FIG. 3B illustrates a top view (not to scale) of MIO-LED (4-in-1) device 300 of the second embodiment of the invention. FIG. 3C illustrates a cross-sectional view (not to scale) of the MIO-LED (4-in-1) device 300, taken along line B-B of FIG. 3B. FIGS. 1B and 1C show that LEDs 312, 314, 316, and 318 of MIO-LED (4-in-1) device 300 are arranged physically in a cavity formed by the sidewalls and floor of housing body 310. In particular, LEDs 312, 314, 316, and 318 are mounted on respective pedestals 322 that are arranged within housing body 310, as shown in FIGS. 3B and 3C. Additionally, LEDs 312, 314, 316, and 318 are encapsulated within housing body 310 of 4-in-1 LED device 300 by use of a solid, transparent material 324, which may be formed, for example, from a transparent epoxy; the epoxy might be blended, with a quantity of YAG-phosphor 328, as shown in FIG. 3C.

With continuing reference to FIGS. 3A, 3B, and 3C, MIO-LED (4-in-1) device 300 may be formed by a 1×4 array of LEDs. Alternatively, MIO-LED (4-in-1) device 300 may be formed by a 2×2 array of LEDs. Any arrangement is within the scope of the invention. Housing body 310 may be formed of any suitably rigid, lightweight, thermally-conductive, and electrically non-conductive material, such as, but not limited to, molded plastic or ceramic. Housing body 310 provides a cavity within which LEDs 312, 314, 316, and 318 are mounted. The cavity is formed by a set of sidewalls and a floor, as shown in FIGS. 3B and 3C. The length, width, and height of housing body 310 may vary. An example length, width, and height may be 6.5×5.5×2.5 mm, respectively. Leads 320 are formed of electrically conductive material, such as, but not limited to, a gold plated copper alloy. Leads 320 may be any standard lead structure, such as a surface-mount type lead. On a given side of housing body 310, the spacing between leads 320 may be, for example, 1.78 mm.

LED 312, LED 314, LED 316, and LED 318 may be standard LED die devices of various application- or user-defined color combinations that produce white light. In particular, the combination of the individual colors emitted by LED 312, LED 314, LED 316, and LED 318, respectively, mix to produce a white light and, thereby, render 4-in-1 LED device 300 a white illumination device. In a preferred embodiment, at least two of LED 312, LED 314, LED 316, and LED 318 are blue LEDs, while the color of the remaining two LEDs may be vary (e.g., various combinations of red, green, blue, yellow, orange, cyan, and/or magenta). The placement of the two blue LEDs within the physical 1×4 or 2×2 array arrangement of LED 312, LED 314, LED 316, and LED 318 is inconsequential. In one example, LED 312 is a red LED, LED 314 is a blue LED, LED 316 is a blue LED, and LED 318 is a green LED i.e. red may be adjacent to blue, which is adjacent to another blue, which is adjacent to green. In another example, LED 312 is a yellow LED, LED 314 is a blue LED, LED 316 is a blue LED, and LED 318 is a cyan LED i.e. yellow may be adjacent to blue, which is adjacent to another blue, which is adjacent to cyan. MIO-LED (4-in-1) device 300 is not limited to the examples cited above; other colour combinations and arrangements are possible.

LED 312, LED 314, LED 316, and LED 318 may each be mounted on pedestals 322, respectively, which reside within the cavity formed by housing body 310. Each pedestal 322 may be formed of an electrically conductive material, such as, but not limited to, copper, aluminum, silver, or gold. By use of each pedestal 322, electrically conductive wires (not shown) may be bonded between the anode and cathode of each LED and its respective pair of leads 320 and, thus, an electrical connection is formed therebetween, as shown in FIG. 3A. Pedestals 322 and, thus, LED 312, LED 314, LED 316, and LED 318 may be placed on a pitch of, for example, 0.95 mm.

LED 312, LED 314, LED 316, and LED 318 are may be encapsulated within housing body 310 by use of a solid, transparent material 324, which material encloses and connects the light emitting parts. Solid, transparent material 324 may comprise, for example, a blend of transparent epoxy (e.g., epoxy 326); the solid, transparent material epoxy might be blended with a quantity of phosphor material (e.g., YAG-phosphor 328). The combination of phosphor material with a blue LED produces a high-brightness white light source. Epoxy 326 and YAG-phosphor 328 of solid, transparent material 324 are substantially identical in form and function to epoxy and YAG-phosphor of the solid, transparent material 224, as described in FIGS. 2A, 2B, and 2C. Again, a benefit of the presence of phosphor material (e.g., YAG-phosphor 328) within epoxy is that the phosphor material acts to diffuse the light that is emitted by LED 312, LED 314, LED 316, and LED 318. As a result, MIO-LED (4-in-1) device 300 is converted from a point-emitting light source to a surface-emitting light source, which is more suited for functional lighting applications.

Because blue LEDs tend to have a shorter lifetime than R and G, the presence of two blue LEDs in the MIO-LED device allows the user to activate one blue LED only and then activate the second blue LED only when the first blue LED begins to fail. Alternatively, both blue LEDs may be activated simultaneously, but at a reduce power level, which prolongs their lifetime. In both cases, a technique is provided for prolonging the overall lifetime of the device due to failure of the blue LED. An additional benefit of including two blue LEDs is that in the event that, should the solid-transparent material discolor (e.g. turn brown) over time, activating the second blue LED can help overcome the losses due to the aged transparent material. This technique can also be applied to other LEDs dependent on their lifetime characteristics.

In the case wherein MIO-LED (4-in-1) device 300 includes R, G, B+YAG, and B+YAG, the combination thereof provides the mechanism by which the CT may be determined and adjusted, as compared with standard light sources. Furthermore, by varying the current that is supplied to LED 312, LED 314, LED 316, and LED 318, the colors of the LEDs may change slightly, which then has a positive effect on producing a higher CRI. Additionally, 4-in-1 LED device 300 or higher (>4-in-1) MIO-LED device provides a yet further expanded (multi-spectra) device as compared with 3-in-1 LED device 200, which results in a yet higher CRI.

In another example configuration, MIO-LED (4-in-1) device 300 includes R, G, O and B+YAG, which provides a yet further expanded (multi-spectra) device for achieving a yet higher CRI. Because all three LEDs of MIO-LED (3-in-1) device 200 and MIO-LED (4-in-1) device 300 are activated simultaneously, their power rating may be reduced for a certain illumination as compared with one white LED only that produces the same illumination. For example, each LED may dissipate 250 watts only as compared to one device that dissipates 1 to 5 watts. Therefore, the thermal management system (not shown) for MIO-LED devices of the present invention (e.g. MIO-LED (3-in-1) device 200 or MIO-LED (4-in-1) device 300) may be simplified as compared with high-power LEDs. Additionally, the combination of multiple (e.g., three or four) LEDs in a single package produces a surface-emitter device, instead of a point-emitter device.

In the case wherein MIO-LED (4-in-1) device 300 includes R, G, B+YAG, and B+YAG, the combination thereof provides the mechanism by which the CT may be determined and adjusted, as compared with standard light sources. Furthermore, by varying the current that is supplied to LED 312, LED 314, LED 316, and LED 318, the colors of the LEDs may change slightly, which then has a positive effect on producing a higher CRI. Additionally, 4-in-1 MIO-LED device 300 (or other >4-in-1 MIO-LED device) provides a yet further expanded (multi-spectra) device as compared with 3-in-1 LED device 200, which results in a yet higher CRI.

Separate leads for each LED of MIO-LED (3-in-1) device 200 and MIO-LED (4-in-1) device 300 (or other >4-in-1 MIO-LED device) allows individual control of forward bias voltage (e.g., R=2 volts, B and G=4 volts). However, the present invention is not limited to separate leads. Alternatively, 3-in-1 LED device 200 and MIO-LED (4-in-1) device 300 may include a common lead to drive multiple LEDs when operating, for example, in a common anode or common cathode configuration.

Because the human eye is very sensitive to variations in white light, combining R and G with B+YAG provides a mechanism for obtaining a high CRI. Compensating the individual color differences between the MIO-LEDs B+YAG alone provides a broad range of about 75% CRI, but adding R and G to B+YAG allows, for example, the device to be adjusted to 6900K and held constant. Adding R and G to B+YAG allows compensation to move light along the CT curve (see FIG. 1). The result is a MIO-LED device (e.g. a MIO-LED (3-in-1) device 200 or MIO-LED (4-in-1) device 300) of the present invention provide a white light illumination device that has a CT in the range of 3200K to 9500K and a CRI of 90 and above.

### Other Embodiments of a MIO-LED Device

Furthermore, the present invention is not limited to MIO-LED 3-in-1 and 4-in-1 devices, n-in-1 devices are possible. For example, a 6-in-1 device may be formed by use of R, G, B+YAG and Y, C, B+YAG. R, G, B+YAG allows of CT shift toward red only, whereas Y, C, B+YAG further allows a CT shift toward blue (See FIG. 1). In this example, further adjustability is provided. In all examples of MIO-LED (3-in-1) device 200, MIO-LED (4-in-1) device 300, and n-in-1 devices, adding two or more colors, such as R and G, to B+YAG adds more light spectra, which increases the CRI and, thus, increases the light quality. It can also give the user the opportunity to optimize for different lighting requirements.

Furthermore, in all examples of MIO-LED (3-in-1) device 200, MIO-LED (4-in-1) device 300, and n-in-1 devices, the solid, transparent material may be silicon based instead of epoxy based, as the use of silicon may increase the lifetime of the device. Additionally, in all examples of MIO-LED (3-in-1) device 200, MIO-LED (4-in-1) device 300, and n-in-1 devices, the LEDs may be replaced with organic LED (OLED) devices to produce a white light source that is suitable for functional lighting applications.

### Modules and Methods Incorporating MIO-LEDs

One embodiment of the present invention is a module 100 that incorporates a plurality of MIO-LED devices as described above. In the following description, reference is made to FIG. 4 which depicts a plurality of MIO-LED devices 120 present in a module 100. The plurality of MIO-LED devices 120 (e.g. 120-1) may configured as an LED array 118. The LED array comprises an arrangement of LEDs, which together project light from the array, combining their light output. The array may comprise columns and rows as depicted in FIG. 5. However it is not limited to such as arrangement, and may alternatively be arranged, for example, circularly, spirally, irregularly etc.

The array may comprise, for example, a RGB+YAG MIO-LED (3-in-1) device that is described above. Because the B+YAG LED produces white light, the RGB+YAG MIO-LED device is referred to as the RGW MIO-LED device. In another example, an MIO-LED device 120 of LED array 118 may be an orange, cyan, and blue (OCB) MIO-LED device that is described above. Two or more MIO-LED devices 120 may be different, for example, the array 118 may comprise various combinations of MIO-LED devices described above, such as a combination of RGW and OCB MIO-LED devices. More details of an example LED configuration that includes a combination of two MIO-LED devices are described with reference to FIG. 4. The MIO-LED devices described may be 3-in-1 devices, i.e. having only three LEDs, or may comprise additional LEDs so forming, for example, a 4-in-1, 5-in-1, 6-in-1 etc. device.

Current sources 122-1 through 122-n are associated with MIO-LED devices 120-1 through 120-n, respectively, and each represents multiple current source devices (e.g. a current source 122 for the R LED, a current source 122 for the G LED, and a current source 122 for the W LED). Thus, each of the LEDs within each MIO-LED device 120 may have a dedicated current source 122.

Current sources 122 may be any commercially available constant current sources that are capable of supplying a constant current, typically in the range of 5 to 80 milliamps (mA), to MIO-LED devices 120. One example constant current device includes, but is not limited to, the DM132 16-channel PWM-controlled constant current driver, supplied by Silicon Touch Technology Inc. (Taiwan).

The module 100 of the present invention may comprise a DAC 124 that is connected to the MIO-LED devices 120 so as to control the brightness of each LED, or of a set (e.g. 2, 3, 4, 5, 6 or more) of LEDs therein. Thus, there may be one DAC per LED or one DAC per set of LEDs. Where one DAC 124 controls a set of LEDs, the LEDs in the set may be the same colour. This allows an arrangement a cluster of MIO-LEDs devices (e.g. 2, 3, 4, 5 or 6 or more) is controlled by one DAC 124 for each colour of LED present. For example, where the MIO-LEDs devices in a cluster each contain RGB+YAG LEDs, there may be 3 DACs 124 controlling this cluster, one for each colour present in each MIO-LED device.

An example of a configuration of the DAC 124 present in an LED circuit 110 is shown in FIG. 4. The DAC 124 may be any commercially available digital-to-analog converter device. DAC 124 may have, for example, 8-bit, 10-bit, or 12-bit resolution. The digital input of DAC 124 may be provided by DSP 112 and multiple analog outputs of DAC 124 feed respective current sources 122. As a result, DAC 124 is used for setting the current value of each current source 122 according to the digital input of DAC 124. LED circuit 110 is not limited to a single DAC 124 that feeds all current sources 122, as shown in FIG. 4. Alternatively, LED circuit 110 may include a combination of multiple DACs 124 in order to set the current values of current sources 122. In one example, DAC device may be, but is not limited to, the AD5308 8-channel DAC, supplied by Analog Devices (Norwood, Mass.).

Each of the LEDs within MIO-LED device 120 may be connected to a dedicated PWM switch 126 which permits on/off control of the MIO-LED 120 or of each LED therein, using a signal. For example, pulse-width modulation (PWM) switches 126-1 through 126-n are associated with MIO-LED devices 120-1 through 120-n, respectively; each may represent multiple PWM switch devices (e.g., a PWM switch 126 for the R LED, a PWM switch 126 for the G LED, and a PWM switch 126 for the W LED). Each PWM switch 126 (e.g., each PWM switch 126-1 through 126-n) of LED circuit 110 may be an electronic switch, such as a FET switch, that is used to connect or disconnect a given current source 112 from its respective LED via a PWM signal (not shown) that is generated by DSP 112. As is well known, pulse width modulation is a technique for controlling an analog circuit, such as LED circuit 110, with the digital outputs of a processor, such as DSP 112. Each LED within a MIO-LED device 120 may have a dedicated combination of one current source 122 and one PWM switch 126, which allows individual control of each LED within the MIO-LED device, which is represented by one MIO-LED device 120 in FIG. 4.

The PWM switch 126 may be used to dim a MIO-LED device 120. The technique of PWM dimming is useful, since it allows the colour output of an LED to remain essentially constant as the current is not altered during dimming (only the duration of pulses provided to an LED). However, it is not the most efficient dimming method, since the current supplied to the LED remains the same using PWM dimming even at very low light outputs. The present invention, instead, may employ current dimming. It may overcome the changes in colour output of an MIO-LED device 120 at different currents by characterising a MIO-LED device at various currents. The system may overcome changes in colour output at different currents by altering the relative colour output of each LED within said MIO-LED device 120. This characterisation may be performed in the factory, and the association between current, colour and light output provided as information held in a memory which the DSP can access. According to one aspect of the invention, dimming is performed using a mixture of PWM control and current control.

Storage device 128 of LED circuit 110 may be present in a module 100 of the present invention configured to provide data to the DSP 112. Storage device 128 storage device is connected so as to provide information to a DSP 112 regarding behavior of the module. Example of color information that may stored in storage device 128 includes, but is not limited to, current vs. color behavior and light output vs. temperature. The storage device 128 may be any non-volatile storage medium, such as a random access memory (RAM) device, a programmable read-only memory (PROM) device, or erasable programmable read-only memory (EPROM) device. The storage capacity of storage device 128 is equal to or greater than that required to store color data for each MIO-LED device 120, which is used for color compensation of each MIO-LED device 120, as needed, during the operation of LED module system 100.

The color data that is stored in a storage device 128 may be determined at the time that the components of LED circuit 110 are assembled (i.e., at manufacture). This color data may be stored within storage device 128 at the time of assembly or, alternatively, stored when LED module system 100 is placed in the field.

The module 100 of the present invention, may comprise one or more temperature sensors 130 configured to provide data to the DSP 112 as indicated in LED circuit 110. Temperature sensors 130 are commercially available temperature sensing devices for sensing the operating temperature of the physical instantiation of LED module system 100, such as a printed circuit board that is associated with LED circuit 110. In particular, a plurality of temperature sensors 130 may be installed in close proximity to the physical instantiation of LED array 118 and in a distributed fashion with respect to the area consumed by LED array 118. The outputs of temperature sensors 130 are fed to DSP 112, in order for DSP 112 to apply color compensation of MIO-LED devices 120 that is based on temperature variations. Additionally, temperature sensors 130 may be used to measure the internal temperature of the packaging (FIGS. 5 to 10) of LED module system 100. DSP 112 may use the information from temperature sensors 130 to control cooling mechanisms of the packaging of LED module system 100, in order to maintain a constant temperature therein. In one example, temperature sensor device may be, but is not limited to, the AD7415 temperature sensor, supplied by Analog Devices (Norwood, Mass.).

The module 100 of the present invention may comprise one or more IR sensors 132. The IR sensor may be configured to provide a signal to the DSP 112 as indicated in LED circuit 110. The IR sensor 132 may be a commercially available IR sensing device for sensing IR signals from a remote control device (not shown), which is used for operating LED module system 100. A digital output of IR sensor 132 feeds DSP 112, which interprets and responds to the remote control commands accordingly. One example IR sensor device includes, but is not limited to, the TSOP 341 IR sensor, supplied by Vishay Intertechnology, Inc.(Malvern, Pa.). Remote control functions that are received via IR sensor 132 and interpreted by use of DSP 112 include, but are not limited to, brightness adjustment, individual color adjustment, pattern selection, color temperature selection, CRI selection, and so forth. The remote control device (not shown) may be any commercially available universal remote control unit, such as used with televisions or DVD players. One example remote control unit that is suitable for use with LED module system 100 is the Philips ProntoPRO TSU6000 universal remote control device, supplied by Royal Philips Electronics N.V, (Amsterdam, Netherlands).

DSP 112 of LED module system 100 may be a general-purpose microprocessor for processing standard microprocessor instructions. DSPs usually support a set of specialized instructions to perform common signal-processing computations quickly. In one example, DSP device may be, but is not limited to, the TI2802 DSP by Texas Instruments (Dallas, Tex.). DSP 112 manages the overall operation of LED module system 100. Functions that are managed by use of DSP 112 and that provide multi-functionality to LED module system 100 include, but are not limited to, communications control, on/off control of individual MIO-LED devices 120, on/off control of entire LED array 118, cooling system control, power management control, variable brightness control (i.e., dimming), variable color control, variable operating efficiency control, and variable CRI control. In doing so, the operations of DSP 112 include, but are not limited to, the following:
interpreting and responding to control information that is received via IR sensor 132 from a remote control device;
interpreting and responding to control information that is received via network interface 114 from an external controller device, such as a computer;
interpreting information that is received from temperature sensors 130, in order to control a cooling mechanism (not shown); p0 interpreting information that is received from temperature sensors 130, in order to apply temperature compensation as needed to LED circuit 110 that is based on information, such as light output vs. temperature data, within storage device 128; and
applying color compensation as needed to LED circuit 110 that is based on information, such as current vs. color behavior data, within storage device 128.

In performing the above operations, the function of DSP 112 is to calculate constantly the optimal values for controlling the light output of each MIO-LED device 120. When DSP 112 receives a request for a certain amount of light for a certain color, DSP 112 responds such that LED circuit 110 is optimized for efficiency or for CRI.

The DSP 112 may be configured so that the CT and brightness of the light emitted from each MIO-LED device 120 is adjusted to be identical. In other words, the DSP 112 may send control signals which adjust the power to the LEDs, such that the CT and brightness of the light emitted from each MIO-LED device 120 is uniform within each module. As mentioned above, the DSP may be configured to maintain the CT and brightness.

Alternatively, the DSP 112 may be configured to adjust the CT and brightness of the light emitted from each MIO-LED device 120. This application may be useful when a module 100 is used as part of a monitor for the display of images such as video, static pictures or computer.

The module 100 of the present invention may comprise one or more Network interfaces 114. The Network interface 114 may be configured to exchange control signal and data with the DSP 112 as indicated in LED circuit 110. Network interface 114 of LED module system 100 provides a communications interface between LED module system 100 and an external control device, such as a computer (not shown). The design of network interface 114 may be communication protocol-specific. Alternatively, the design of network interface 114 may support multiple communication protocols.

Communication protocols that may be supported by network interface 114 include, but are not limited to, Digital Addressable Lighting Interface (DALI); DMX/DMX512 and DVI/HDMI, which are digital video/data protocols; Recommended Standard 232 (RS-232); Recommended Standard 485 (RS-485); Controller Area Network (CAN); Serial Digital Interface (SDI); High Definition Serial Digital Interface (HD SDI); Ethernet; Art-Net Ethernet; ZigBee wireless; and Bluetooth wireless.

Power supply 116 of LED module system 100 is configured to receive a source of power (e.g. 90-250 VAC, 50-60 Hz), and transform it, if necessary, for supply to the LEDs and other components. The power supply 116 may be a custom switch-mode power supply. As is well known, a switch-mode power supply incorporates power-handling electronic components that are continuously switching on and off with high frequency and, thus, the output voltage is controlled by varying duty cycle, frequency, or a phase of these transitions. The input of the power supply 116 may be an alternating current (AC) voltage (VAC) in the range of 90-264 VAC, 50-60 Hz. For example, the input voltage may be 110 or 220 VAC. Alternatively, input of power supply 116 may be obtained from an electromagnetic induction source as described below. The power supply 116 may be designed to provide, for example, 25 watts and may include a power factor correction (PFC) feature, which is a technique of counteracting the undesirable effects of electric loads that create a power factor (p.f.) that is less than 1. Power supply 116 provides power for all active electronic devices within LED module system 100. In particular, power supply 116 produces multiple LED voltages (V-LEDs of LED circuit 110) for powering MIO-LED devices 120, which includes LEDs of different colors (each color requires a different V-LED voltage). Table 4 below shows example DC voltages that are associated with each LED color.

TABLE 4
Example V-LED voltages

| LED color | DC volts |
|---|---|
| RED | 2.5 max |
| GREEN | 3.5 max |
| WHITE (B + YAG) | 3.5 max |
| BLUE | 3.5 max |
| CYAN | 4.0 max |
| ORANGE | 3.3 max |

According to one embodiment, the invention, the voltage output of the power supply 116 is adjustable according to the required power. For example, e.g. a white LED may have a max V-LED voltage of 3.5V specified at 20 mA current. Another LED may have a V-LED of 3.2V specified at 10 mA of current. When optimizing for efficiency, the power supply maybe configured to receive a signal from the DSP to adjust the voltage output, for example, from 3.5V to 3.2V.

Additionally, power supply 116 may provide power for a cooling fan (shown in FIGS. 6 and 8) that is associated with the packaging of LED module system 100. The output voltage for the cooling fan may be, for example, in the range of 2 to 5 volts DC. Alternatively, the DC voltage may be held constant and the fan may be driven using PWM. The power of the fan may thus be regulated. This is advantageous where it is important to maintain efficiency i.e. reduce power input by reducing fan activity, or to reduce noise also by reducing fan activity.

Additionally, the LED module system 100 may include a rechargeable battery (not shown), which provides power to LED module system 100 of modular LED device 200 in the event that AC power source is lost. It may be charged by power regulator 116 when the power source is present.

While the use of AC or DC power is mentioned above, the power input to the power supply 116 may be directly or indirectly using electromagetic induction. Thus, the LED module system 100 may include a receiving part for an inductively coupled power. In such a system, an induction coil (secondary coupler), part of LED module system 100, receives power by induction from an external coil (primary coupler). The external coil may be integrated into a supporting frame for the system. This may allow the LED module system to operate without power cables, so greatly simplifying setting up the system. The power transferred by the inductive arrangement may range from sub 1 Watt (e.g. 100 mW) to hundreds of Watts.

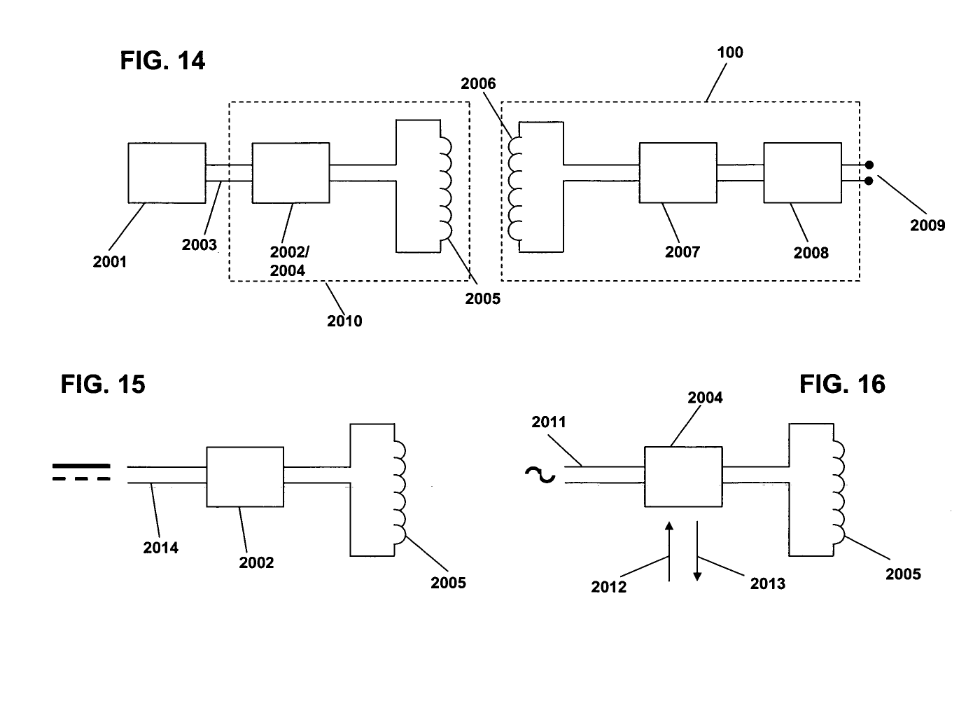

An implementation of inductive coupling to transfer energy from a power source towards the lighting system is exemplified in FIG. 14. An external inductive power supplier 2010 comprises a primary coupler 2005 that receives power 2001 from a main source (e.g. mains AC power at 50 Hz, or AC current at 1 to 200 kHz) through cables 2003. The inductive power supplier 2010 may convert the power 2001 as necessary and provide it to the primary coupler 2005 in a form that can be transmitted wirelessly to a receiving coil (secondary coupler) 2006 that is part of the LED module system 100. Additional circuitry 2002, 2004 may be present in the inductive power supplier 2010 to perform the task of, for example, converting the power source 2001 to a high-frequency waveform, and/or to receive/transmit data information utilising the primary coupler 2005; the inverter 2002 (if necessary), and data modulator and/or demodulator 2004 are respectively indicated in FIG. 14.

The LED module system 100 may comprise a secondary coupler 2006 which receives wirelessly power by inductive coupling from the primary coupler 2005. The power output 2009 is provided directly or indirectly as the input to the power supply 116 described above. Additional circuitry 2007, 2008 may also be present in the LED module system 100 to control the voltage of the power output 2009, and/or to add receive/transmit data information utilising the secondary coupler 2006; the voltage controller 2007, and data modulator and/or demodulator 2008 are respectively indicated in FIG. 14.

The respective primary 2005 and secondary 2006 couplers may have any suitable shape. Some shapes might have advantages for efficiency of the energy transfer and some shapes might be optimised so as to allow easy mounting or clicking of the light source onto the couplers primary. Some coupler shapes may allow a flat panel design of both couplers.

Besides using the couplings 2005, 2006 to transfer energy, data transfer may also be exchanged over the couplings 2005, 2006. Data transfer may be bidirectional, i.e. both from the LED module system 100 to the power supplier 2010 and vice versa. Data transfer might be implemented using various modulation techniques (e.g. phase shift key modulation). This technique avoids connections (connectors or plugs) between light sources and the power source and data source. Hence the lamp source can be hermetically closed or sealed for e.g. outdoor use to a certain IP protection level.

The primary coupler 2005 may be integrated within a frame or holding mechanism which mechanically supports the LED module system 100 or housing thereof. The primary coupler 2005 may be included in a cable, possibly connecting more LED module systems 100, which connects to a power source. Via cabling, a plurality of primary couplers 2005 can be interconnected to form a 2D or 3D shape of light sources.

As mentioned above, inductive power supplier 2010 may be incorporate additional circuitry 2002 for converting energy to a waveform frequency suitable for power transfer system; an example of this is show shown (FIG. 15) which depicts an inverter 2002 receiving DC power, which converts it into higher frequency power (e.g. 1 to 200 kHz) for use by the primary coupler 2005.

As mentioned above, inductive power supplier 2010 may incorporate additional circuitry 2002 for generating data transfer (unidirectional or bidirectional) 2012, 2013 if applicable; an example of this is shown (FIG. 16) which depicts a data modulator and/or demodulator 2008 receiving DC power.

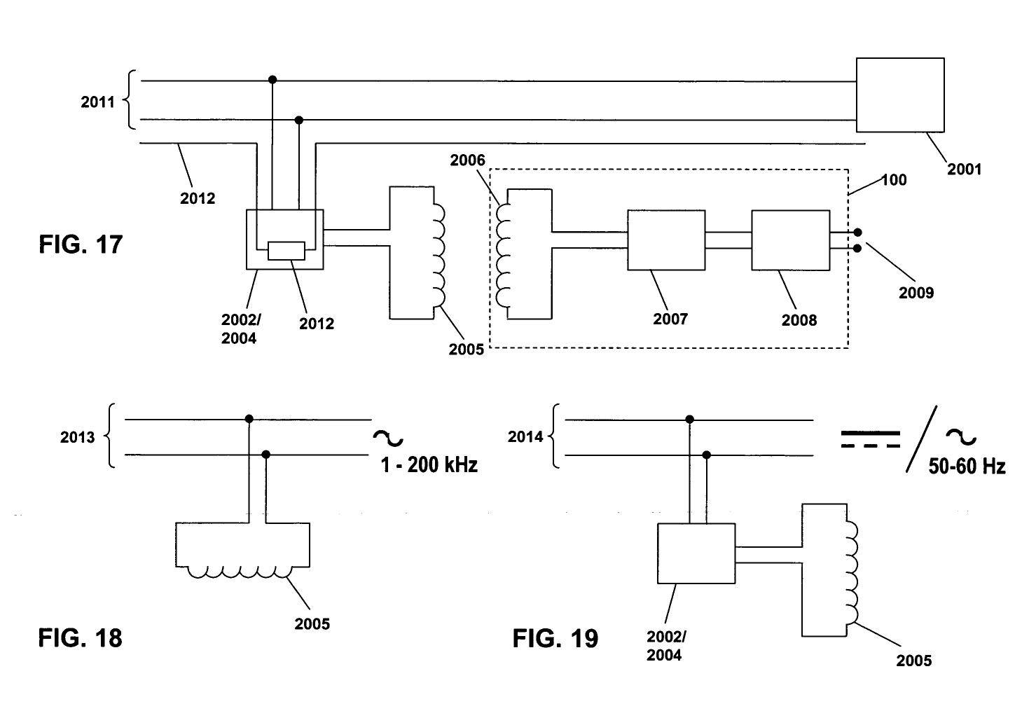

The inductive power supplier 2010 may be incorporate additional circuitry 2015 configured to detect the position of the light source in a string 2012 (or matrix) of light sources (FIG. 17).

As mentioned above, the inductive power supplier 2010 may be powered from traditional mains power (e.g. 120-250 V AC, 50-60 Hz). However, it may alternatively receive power from a high frequency inverter (e.g. 6 to 250V AC, 1-200 kHz). According to one embodiment of the invention, high frequency power for the primary coupler 2001 is separately provided to the inductive power supplier 2010 via a common rail 2013. Such configuration is indicated in FIG. 18. According to another aspect of the invention, mains power or DC power is provided to the inductive power supplier 2010 via a common rail 2014, which power is used to operate the circuitry and the primary coupling via an inverter 2002. The use of common rails allows several light sources to be conveniently coupled to a plurality of inductive power suppliers 2010, where by the power source 2001 is available on common rails. Any common rails 2011, 2013, 2014, or cables connecting the inductive power supplier 2010 can be sealed for outdoor use.

According to one aspect of the invention the common rails 2011, 2013, 2014, connecting the primary coupler 2001 are hermetically sealed outdoor or underwater use.

By changing the power output of the primary coupler, light emitted by the LED module system 100, can be controlled. Such control might be in addition to or an alternative to any electronic control already present in the LED module systems 100.

The LED module system 100 may incorporate electronics e.g. a voltage controller 2007, configured to adjust power or voltage or current received from the secondary coupling 2006. This can be used to compensate for changes in energy received, compensate for tolerances of the coupler and the electronic components, variance in the gap of the wireless coupling.

The LED module system 100 may incorporate electronics e.g. a data modulator and/or demodulator 2008, so as to receive digital data from the primary side and may contain electronics so as to transmit data to the primary side as already mentioned above.

The LED module system 100 may incorporate may contain any IR receiver or transceiver so as to be able adjust the functionality of the light source. This data also might be transmitted to inductive power supplier 2010 for use on a network or to control other light sources in the system.

The LED module system 100 may incorporate any wireless receiver and/or transmitter to communicate with other light sources or control devices for the lighting system.

The LED module system 100 may attach to the primary coupler inductive power supplier 2010 part of the inductive power supplier 2010 by a mounting. Such mounting includes a clickable mounting.

The LED module system 100 may also be hermetically sealed outdoor or underwater application is possible.

With continuing reference to FIG. 4, the operation of LED module system 100 may be as follows. DSP 112 receives commands from a remote control device via IR sensor 132 or from an external controller via network interface 114 and, thus, a user activates LED circuit 110.

Subsequently, a user selects one or more functions or modes of operation of LED module system 100 and LED circuit 110 is set accordingly. For example, a user selects a desired brightness, color, efficiency, and/or CRI. DSP 112 interprets and responds to the user selections by querying the information in storage device 128 for each MIO-LED device 120 and calculating the required current value for controlling each MIO-LED device 120. DSP 112 then sets each current source 122 accordingly via DAC 124. Additionally, DSP 112 monitors continuously temperature data from temperature sensors 130 in order to apply temperature compensation, as needed, and in order to control the cooling system (not shown). Optionally, the correction for achieving uniform color from one MIO-LED device 120 to its neighbors is accomplished digitally via PWM switches 126, while the general light output of each MIO-LED device 120 is controlled via current sources 122. Controlling the light output via current allows for maximum operating efficiency. Additionally, by using the correction data that is stored in storage device 128, peak color rendering and color output levels may be ensured. In summary, the operation of LED module system 100 utilizes the combination of analog LED drive and digital compensation. The electronics of LED module system 100 provides feedback mechanisms by which DSP 112 may calculate and, therefore, adjust, for example, brightness, CRI, and CT.

FIG. 5 illustrates a perspective front view of a modular LED device 201, which comprises a housing and an LED module system 100 of FIG. 4. Modular LED device 201 is the physical instantiation of a modular LED device that provides a generic building block that is easy to use and suitable for multiple lighting applications. Modular LED device 201 may include an LED board 250 upon which is mounted the components of LED circuit 110 of LED module system 100 of FIG. 5. Modular LED device 201 may further include a housing/heatsink 252. Housing/heatsink 252 serves as the package for all electrical components of LED module system 100 and facilitates the thermal management system. Additionally, modular LED device 201 may include a set of screws/spacers 254 for fastening LED board 250 to housing/heatsink 252 and, optionally, for optionally attaching one or more optical devices (e.g., lens, filter, diffuser) to the face of LED board 250. Optionally, the outer face of LED board 250 may include silicon layer, in order to provide a barrier against contamination or water intrusion.

Also shown in FIG. 5 is a Detail A of a 3-in-1 LED device 256, which is one example of one MIO-LED device 120 of LED circuit 110 of LED module system 100 of FIG. 1. FIG. 5 shows that 3-in-1 LED device 256 includes, for example, three LEDs 258. LEDs 258 may be, for example, RGW or OCB LEDs to form a RGW or OCB MIO-LED device, as described above.

FIG. 6 illustrates a perspective back view of modular LED device 201, which comprises a housing and an LED module system 100 of the present invention. FIG. 6 shows that modular LED device 201 further including a set of click points 220 that are installed in housing/heatsink 252, a cooling fan 260 mounted in the rear of housing/heatsink 252 that is secured by a fan guard 262, an AC power port 226, and one or more (e.g., two) I/O ports 264.

Referring again to FIGS. 5 and 6, LED board 250 may be a multi-layer printed circuit board (PCB) for implementing LED circuit 110 of LED module system 100 of FIG. 4. In particular, the outer face of LED board 250, as shown in FIG. 5, is a physical instantiation of LED array 118 of LED circuit 110, where MIO-LED devices (e.g. 3 in 1) 256 of LED board 250 equate to MIO-LED devices 120 of LED circuit 110. Mounted on the inner side (not shown) of LED board 250 are the supporting electrical components of LED circuit 110 (e.g., current sources 122, DAC 124, PWM switches 126, storage device 128, temperature sensors 130, and IR sensor 132). In particular, temperature sensors 130 (not visible) are installed in a distributed fashion across the area of LED board 250.

Additionally, a small hole (not shown) that is associated with IR sensor 132 is provided within LED board 250, in order to provide a line-of-sight port for receiving IR signals from a remote control device.

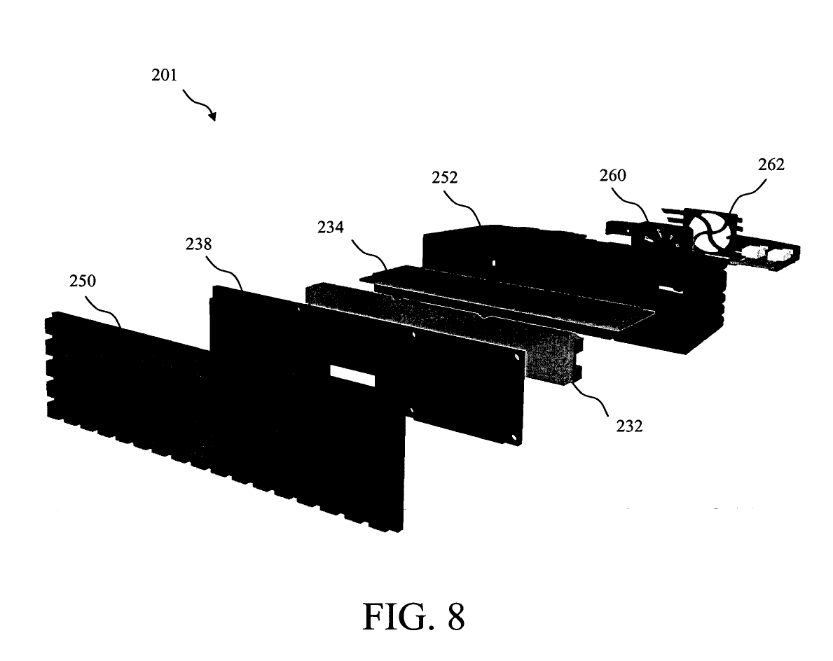

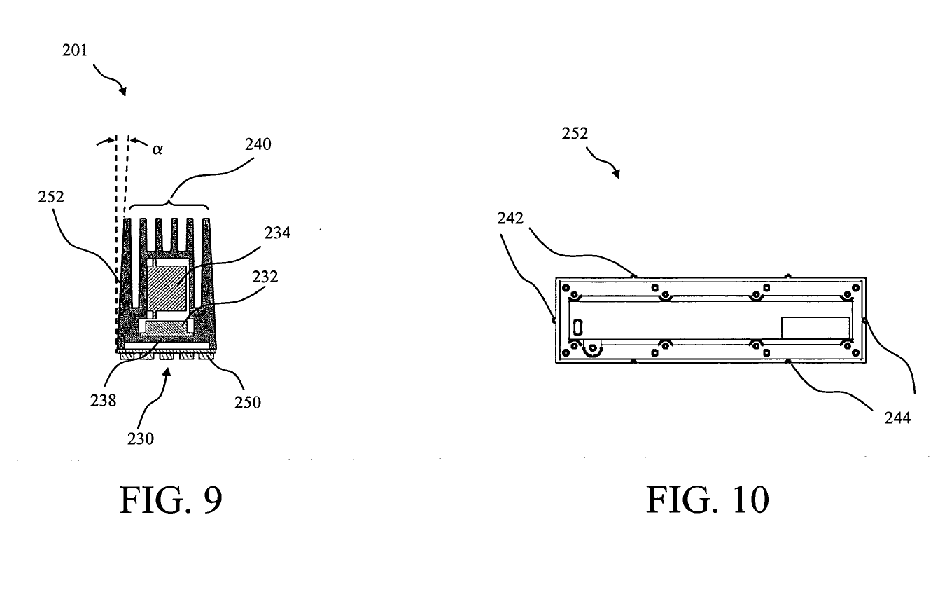

FIG. 9 illustrates a cross-sectional view of modular LED device 201, which comprises a housing and the LED module system 100 of the present invention. taken along line A-A of FIG. 2. FIG. 9 shows PCB assembly 230 as well as mounting plate 238 secured within housing/heatsink 252. Additionally, FIG. 9 shows that housing/heatsink 252 includes a plurality of cooling fins 240 for providing a large surface area from which to dissipate heat. Furthermore, the outer cooling fins 240 may be tapered at an angle α, such that the portion of housing/heatsink 252 that accommodates LED board 250 has a greater dimension than the opposite portion of housing/heatsink 252. Angle α may be in the range of, for example, 2 to 15 degrees, with a specific example of 4 degrees. Although a single modular LED device 201 may be used as a standalone lighting device, in the case of an LED lighting device that is formed of a configuration of multiple generic modular LED devices 201, the tapered sides of modular LED device 201 allow multiple modular LED devices 201 to be assembled one to another with a slight curvature. The tapered modular LED device 201, therefore, allows its use in a lighting application that requires a curved surface, again demonstrating the multi-functionality of modular LED device 201.

FIG. 10 illustrates a front view of a housing/heatsink 252 of modular LED device 201 that houses LED module system 100 of the present invention. In particular, FIG. 10 shows the portion of housing/heatsink 252 that accommodates LED board 250 and mounting plate 238. FIG. 10 shows that housing/heatsink 252 further includes a set of alignment notches 242 and alignment detents 244 that are arranged along its outer perimeter. Although a single modular LED device 201 may be used as a standalone lighting device, in the case of an LED lighting device that is formed of a configuration of multiple generic modular LED devices 201, the combination of click points 220 (shown in FIG. 6), alignment notches 242, and alignment detents 244 provide mechanisms for easy assembly of modular LED devices 201 to another. For example, alignment notches 242 of one modular LED devices 201 are easily aligned and fitted to alignment detents 244 of a neighboring modular LED devices 201.

Likewise, click points 220 of one modular LED devices 201 may easily aligned and fitted to click points 220 of a neighboring modular LED devices 201. Accordingly, modular LED device 201 provides a universal building block for forming a lighting device for any lighting application.

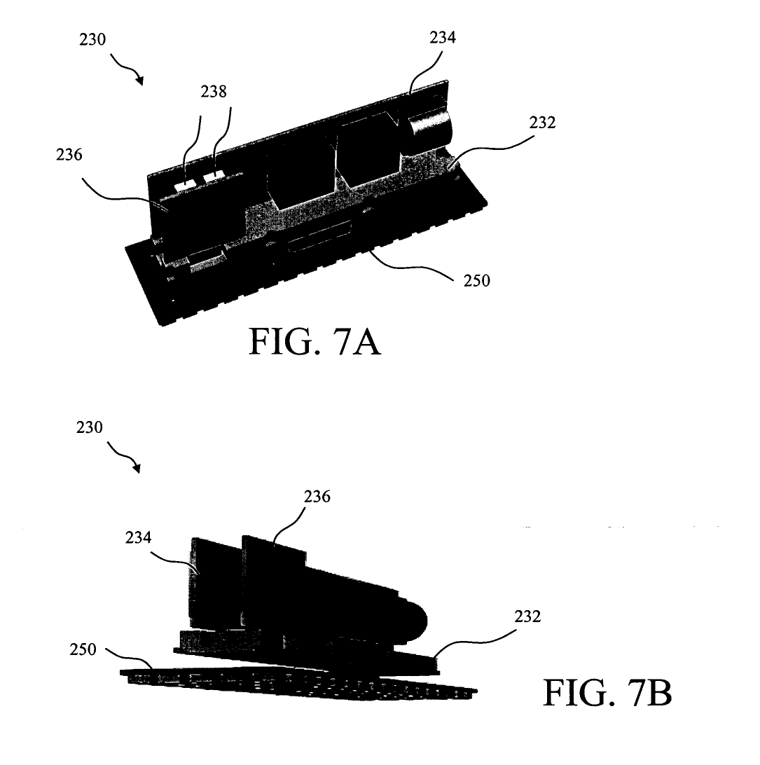

Referring again to FIGS. 5 and 6, housing/heatsink 252 may be formed of a material, such as, but not limited to, aluminum or magnesium, that has high thermal conductivity and that is lightweight. The design of housing/heatsink 252 in combination with cooling fan 260 provides uniform heat transfer throughout modular LED device 201 and, thus, provides uniform heat dissipation. The inner portion (not visible) of housing/heatsink 252 may include built-in airflow guides, in order to distribute effectively the airflow from cooling fan 260 to hotspots within modular LED device 201. Housing/heatsink 252 may further include clearances for installing the electronics (e.g., in the form of PCBs) that are associated with LED module system 100, which are shown in more detail in FIGS. 7A, 7B, and 8.

According to one embodiment of the invention, the housing/heatsink 252 may include an interfacing material which can be used to make contact with other heat conductive materials, so as to transfer heat from the device more easily.

Referring again to FIGS. 5 and 6, cooling fan 260 may be a commercially available DC fan that is suitably small to be installed within housing/heatsink 252 and that provides a cubic feet per minute (CFM) of airflow that adequate to cool modular LED device 201 when operating. In one example, cooling fan 260 may be the AFB03505HA fan, supplied by Delta Electronics, Inc. (Fremont, Calif.), which is a 5.50 CFM fan that has a diameter of 35 millimeters (mm). In another example, cooling fan 260 may be the AFB0305MA fan, supplied by Delta Electronics, Inc. (Fremont, Calif.), which is a 3.00 CFM fan that has a diameter of 30 millimeters (mm).

Cooling fan 260 is recessed and is, thus, flush with the rear surface of housing/heatsink 252 and is secured by a fan guard 262, as shown in FIG. 6. In the event that the back of housing/heatsink 252 abuts an obstacle, cooling fan 260 will continue to rotate and draw air from the ends of housing/heatsink 252. Cooling fan 260 may be completely temperature controlled via the combination of DSP 112 and temperature sensors 130. Additionally, cooling fan 260 may be turned off in some applications in order to achieve noise reduction and/or to prolong the lifetime of cooling fan 260. Fan guard 262 may be formed of any lightweight and rigid material, such as molded plastic, and includes clearances for AC power port 226, and, for example, two I/O ports 264. AC power port 226 may be a standardized receptacle for connecting the AC input voltage (e.g., 110 or 220 VAC) to the power regulator 116. I/O ports 264 may be standardized receptacles for connecting communications cables for the various communication protocols that are described in FIG. 4. In particular, the first I/O port 264 may provide an I/O connection to the electronics of modular LED device 201, whereas the I/O signals may be passed in a daisy-chain fashion via the second I/O port 264 to another instance of modular LED device 201. In this way, an LED lighting device may be formed of a configuration of multiple generic modular LED devices 201.

Referring again to FIGS. 5 and 6, modular LED device 201 may be formed of any user-defined array of MIO-LED devices 256 and, thus, its dimensions may vary accordingly. By way of example, FIGS. 5 and 6 illustrate an instance of modular LED device 201 that is formed of a 17×5 array of MIO-LED devices 256. In this example, modular LED device 201 may have a depth, d, of between 40 and 50 mm (e.g., 44 mm). If MIO-LED devices 256 are installed on a pitch of, for example, 8.94 mm in the x-dimension, x-pitch, the resulting overall length, l, of modular LED device 201 may be, for example, 152 mm. If MIO-LED devices 256 are installed on a pitch of, for example, 8.55 mm in the y-dimension, y-pitch, the resulting overall height, h, of modular LED device 201 may be, for example, 42.75 mm.

FIGS. 7A and 7B illustrate a first and second perspective view, respectively, of a PCB assembly 230 for forming LED module system 100 of the present invention. PCB assembly 230 includes an arrangement of LED board 250 that is mechanically and electrically connected to a drive control board 232, which is mechanically and electrically connected to a power supply (P/S) board 234 and a network interface board 236, upon which is installed one or more (e.g., two) I/O connectors 238.

Like LED board 250, drive control board 232, P/S board 234, and network interface board 236 may be multi-layer PCBs for implementing the electronics of LED module system 100 of FIG. 4. In particular, drive control board 232 is the physical instantiation of DSP 112 of LED module system 100, which includes a DSP device and associated circuitry, P/S board 234 is the physical instantiation of power regulator 116 of LED module system 100, which includes a compact design of a switch-mode power circuit, and network interface board 236 is the physical instantiation of network interface 114 of LED module system 100, which includes receiver/driver circuitry that is accessed via I/O connectors 238. Network interface board 236 allows up to 512 modular LED devices to be configured one to another. The mechanical and electrical (e.g., signal I/O and power) connections between LED board 250, drive control board 232, P/S board 234, and network interface board 236 are provided via standard multi-pin connectors that allow each PCB of PCB assembly 230 to be easily connected and disconnected at will.

FIG. 8 illustrates an exploded view of modular LED device 201, which houses LED module system 100 of the present invention. In particular, FIG. 8 shows the assembly of LED board 250, drive control board 232, P/S board 234, network interface board 236, cooling fan 260, and fan guard 262 in relation to housing/heatsink 252. As shown in FIG. 8, housing/heatsink 252 includes clearance regions, in order to accommodate all elements therein. More details of housing/heatsink 252 are provided with reference to FIGS. 9 and 10.

Additionally, FIG. 8 shows that modular LED device 201 includes a mounting plate 238 that abuts the inner side of LED board 250. Mounting plate 238 serves as the mechanical and thermal interface between LED board 250 and housing/heatsink 252. The inner surface of LED board 250 is coated with a heat spreading material, such as Gap pad VO Ultra soft 0.125″ thickness GPVOUS-0.125-AC-0816 from The Bergquist Company (Chanhassen, Minn.), in order to transfer heat that is generated by the circuitry of LED board 250 to mounting plate 238 and then to housing/heatsink 252. The combination of LED board 250 and mounting plate 238 is mechanically attached to housing/heatsink 252 via screws/spacers 254 that are shown in FIG. 5. Mounting plate 238 may be formed of a rigid, lightweight, and thermally conductive material, such as, but not limited to, aluminum or magnesium. A clearance hole within mounting plate 238 accommodates the electrical connector between LED board 250 and drive control board 232.

The design of modular LED device 201, which includes PCB assembly 230, provides a mechanism by which the electronics may be considered as replaceable.

More specifically, PCB assembly 230 and, in particular, LED board 250 in combination with mounting plate 238 may be easily removed from the face of modular LED device 201. Additionally, when LED board 250 in combination with mounting plate 238 is provided as a consumable item, its characterization data and drivers are all inclusive.

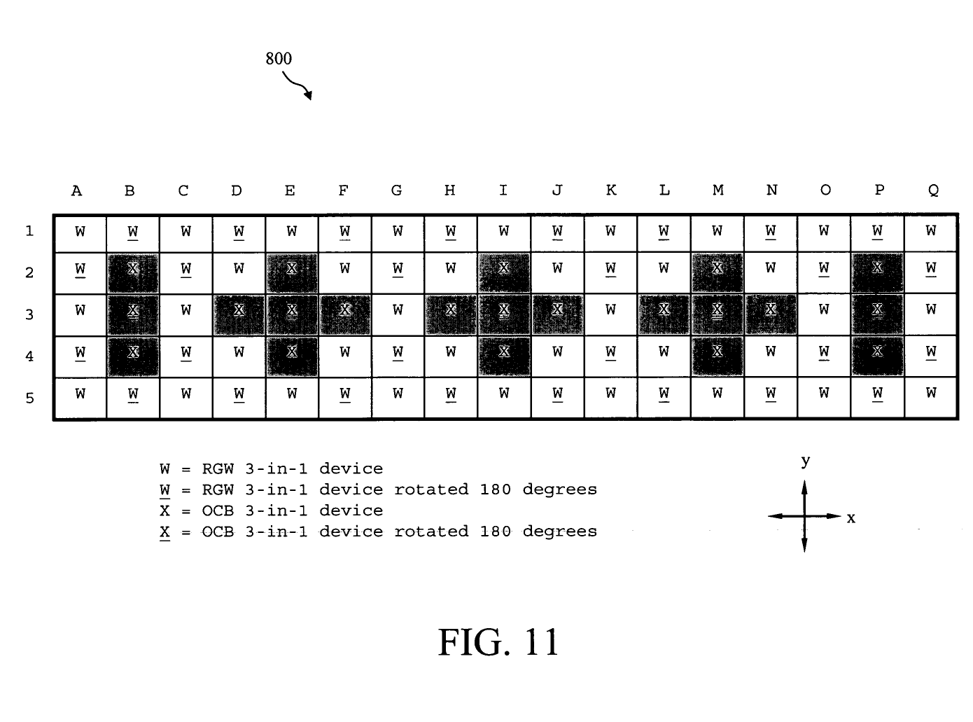

FIG. 11 illustrates an exemplary LED configuration 800 of LED module system 100 of the present invention. By way of example, LED configuration 800 shows a 17×5 array of MIO-LEDs devices. The MIO-LED devices present in configuration 800 are arranged in rows 1 through 5 and in columns A through Q. Additionally, by way of example, the MIO-LEDs devices may be RGW or OCB MIO-LED devices, or a combination of as described above. In particular, FIG. 11 shows a first quantity of RGW MIO-LED devices (W), a second quantity of RGW MIO-LED devices (W) that are rotated 180 degrees from its neighbors, a first quantity of OCB (3-in-1) MIO-LED devices (X), a second quantity of OCB MIO-LED devices (X) that are rotated 180 degrees from its neighbors. The presence of OCB MIO-LED devices in combination with RGW MIO-LED devices provides improved CRI control, as compared with the presence of RGW MIO-LED devices only. Additionally, the presence of OCB MIO-LED devices in combination with RGW MIO-LED devices provides improved efficiency, color, and brightness control, as compared with the presence of RGW MIO-LED devices only. Furthermore, alternating the physical orientation of the RGW and OCB MIO-LED devices in relation to their neighbors provides compensation for differences in the perceived color due to differences in viewing angles.

Example performance specifications for example configurations are as follows.
16×4 LED configuration of 64 RGW MIO-LEDs: x-pitch=9.5 mm, y-pitch=10.69, CRI=92%, brightness=800 lm, CT=3200K, power=22 W;
16×4 LED configuration of 48 RGW and 16 OCB MIO-LEDs: x-pitch=9.5 mm, y-pitch=10.69, CRI=95%, brightness=700 lm, CT=3200K, power=22 W;
17×5 LED configuration of 85 RGW MIO-LEDs: x-pitch=8.94 mm, y-pitch=8.55, CRI=92%, brightness=1100 lm, CT=3200K, power=25 W; and
17×5 LED configuration of 64 RGW and 21 OCB MIO-LEDs: x-pitch=8.94 mm, y-pitch=8.55, CRI=95%, brightness=920 lm, CT=3200K, power=25 W.

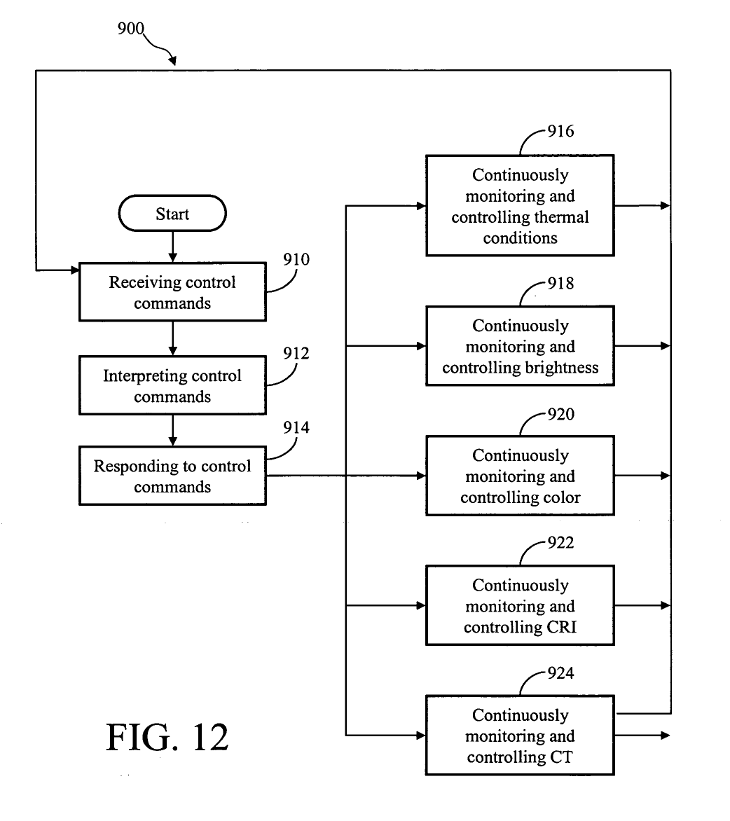

FIG. 12 illustrates a flow diagram of a method 900 of operating an LED module system, such as LED module system 100 of the present invention. In particular, the operation of LED module system 100 utilizes the combination of analog LED drive and digital compensation. Method 900 includes, but is not limited to, the following steps.
At step 910, DSP 112 of LED module system 100 may receive control commands from a remote control device via IR sensor 132 and/or an external controller, such as a computer, via network interface 114. Method 900 proceeds to step 912.

At step 912, DSP 112 of LED module system 100 may interpret the control commands based on a set of predetermined commands for which DSP 112 is programmed to recognize. The predetermined commands may relate, for example, to communications control, on/off control of individual MIO-LED devices 120, on/off control of entire LED array 118, cooling system control, power management control, variable brightness control (i.e., dimming), variable color control, variable operating efficiency control, and variable CRI control. Method 900 proceeds to step 914.

At step 914, DSP 112 of LED module system 100 may respond to the control commands by executing a set of predetermined program instructions for each respective control command. Method 900 proceeds to steps 916, 918, 920, 922, and 924.

At step 916, DSP 112 of LED module system 100 may continuously monitor and control the thermal conditions of modular LED device 201, in order to provide optimal operation. In particular, DSP 112 may interpret information that is received from temperature sensors 130, in order to apply temperature compensation, as needed, to LED circuit 110 that is based on information, such as light output vs. temperature data, within storage device 128. Compensation may be applied to LEDs 118 by DSP 112 controlling current sources 122 via DAC 124 and/or DSP 122 controlling PWM switches 126. Method 900 returns to step 910.

At step 918, DSP 112 of LED module system 100 may continuously monitor and control the brightness of modular LED device 201, in order to provide optimal operation. In particular, DSP 112 may apply brightness compensation, as needed, to LED circuit 110 that is based on information, such as current vs. color behavior data and light output vs. temperature data, within storage device 128. Compensation may be applied to LEDs 118 by DSP 112 controlling current sources 122 via DAC 124 and/or DSP 122 controlling PWM switches 126. Method 900 returns to step 910.

At step 920, DSP 112 of LED module system 100 may continuously monitor and control the color of modular LED device 201, in order to provide optimal operation. In particular, DSP 112 may apply color compensation, as needed, to LED circuit 110 that is based on information, such as current vs. color behavior data and light output vs. temperature data, within storage device 128. Compensation may be applied to LEDs 118 by DSP 112 controlling current sources 122 via DAC 124 and/or DSP 122 controlling PWM switches 126. Method 900 returns to step 910.

At step 922, DSP 112 of LED module system 100 may continuously monitor and control the CRI of modular LED device 201, in order to provide optimal operation. In particular, DSP 112 may apply CRI compensation, as needed, to LED circuit 110 that is based on information, such as current vs. color behavior data and light output vs. temperature data, within storage device 128. Compensation may be applied to LEDs 118 by DSP 112 controlling current sources 122 via DAC 124 and/or DSP 122 controlling PWM switches 126. Method 900 returns to step 910.

At step 924, DSP 112 of LED module system 100 may continuously monitor and control the CT of modular LED device 201, in order to provide optimal operation. In particular, DSP 112 may apply compensation, as needed, to LED circuit 110 that is based on information, such as current vs. color behavior data and light output vs. temperature data, within storage device 128. Compensation may be applied to LEDs 118 by DSP 112 controlling current sources 122 via DAC 124 and/or DSP 122 controlling PWM switches 126. Method 900 returns to step 910.

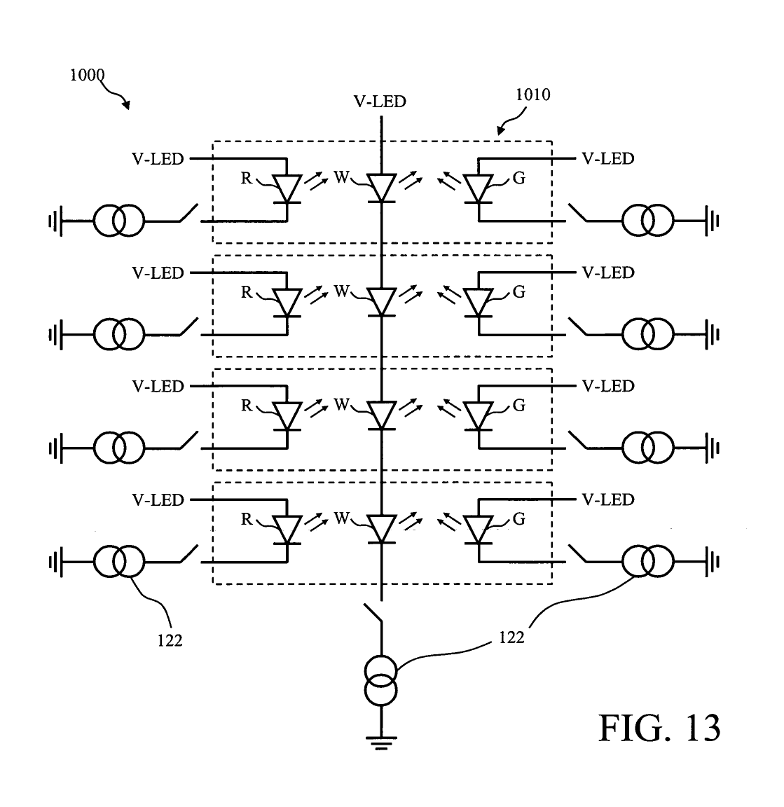

In an alternative circuit arrangement of LED array 118 of LED circuit 110 of FIG. 4 that results in increased efficiency, multiple W LEDs may be driven by a common current source 122, an example of which is shown with reference to FIG. 13. FIG. 13 illustrates an LED circuit 1000 for increased efficiency. LED circuit 1000 shows the W (i.e., B+YAG) LEDs of a plurality of MIO-LED devices electrically connected in series and driven by a common current source 122. By way of example, FIG. 13 shows four MIO-LED (3 in 1) devices 1010, wherein the W LEDs are electrically connected in series and driven by a common current source 122 and wherein all remaining R and G LEDs are driven by separate current source 122. In the arrangement of LED circuit 1000, nine current sources 122 are required, rather than twelve as described reference to LED array 118 of LED circuit 110 of FIG. 4. The reduced number of current source 122 results in increased device efficiency. The scenario of LED circuit 1000 provides less color and brightness control as compared with each W LED having its own dedicated current source 122; however, in a static lighting application brightness uniformity is less critical. Additionally, in this scenario the R LED and G LED, which are driven individually, may be used to provide color compensation.

1. A Light Emitting Diode (LED) module lighting system comprising:
two or more multiple-in-one (MIO) LED devices, each MIO-LED device comprising at least three LEDs together in a housing body, wherein:
light emitting parts of said at least three LEDs are encapsulated in and connected by a solid, transparent material, and
said at least three LEDs each emit a different colour of light, whereby each colour is selected from the group consisting of blue, red, green yellow, orange, cyan, purple, white and magenta;
a digital signal processor (DSP); and
a digital to analogue converter (DAC) for each LED or a set of LEDs, wherein the system is configured so that signals from the DSP regulate the overall colour and brightness of light emitted by the MIO-LED devices by controlling the power applied to each LED or set of LEDs through the DAC.

2. LED module lighting system according to claim 1, wherein the solid, transparent material comprises at least one phosphor material that is activated by light emitted from one or more of said LEDs, so producing light having a spectrum broader than light emitted by said activating LED.

3. LED module lighting system according to claim 2, wherein the phosphor material comprises one or more of the phosphors or optical brighteners, wherein the one or more phosphors comprise:
ZnS:Ag+(Zn,Cd)S:Ag (P4) (white), Y₂O₂S :Eu+Fe₂O₃ (P22R) (red), ZnS:Cu,AI (P22G) (green), ZnS:Ag+Co-on-AI₂O₃ (P22B) (blue), Zn₂SiO₄:Mn (P1, GJ), (yellowish-green (525 nm)), ZnS:Ag,CI or ZnS:Zn (P11, BE), (blue (460 nm)), (KF,MgF₂):Mn (P19, LF) (yellow (590 nm)), (KF, Mg F₂): Mn (P26, LC), (orange (595 nm)), (Zn,Cd)S:Ag or (Zn,Cd)S:Cu (P20, KA), (yellow-green), ZnO:Zn (P24, GE) (green (505 nm)), (Zn,Cd)S:Cu,CI (P28, KE) (yellow), ZnS:Cu or ZnS:Cu,Ag (P31, GH), yellowish-green), MgF₂:Mn (P33, LD) (orange (590 nm)), (Zn,Mg)F₂:Mn (P38, LK), (orange (590 nm)) Zn₂SiO₄:Mn,As (P39, GR) (green (525 nm)), ZnS:Ag+(Zn,Cd)S:Cu (P40, GA) (white), Gd₂O₂STb (P43, GY) (yellow-green (545 nm)), Y₂O₂SiTb (P45, WB), (white (545 nm)), Y₂O₂STb, (green (545 nm)), Y₃AI₅O₁₂)Ce (P46, KG) (green (530 nm)), Y₃(AI₁Ga)₅O₁₂)Ce (green (520 nm)), Y₂SiO₅:Ce (P47, BH) (blue (400 nm)), Y₃AI₅O₁₂:Tb (P53, KJ) (yellow-green (544 nm)), Y₃(AIGa)₅O₁₂Tb (yellow-green (544 nm)), ZnSiAg₁AI (P55, BM) (blue (450 nm)), InBO₃Tb (yellow-green (550 nm)), InBO₃IEu (yellow (588 nm)), ZnSiAg (blue (450 nm)), ZnSiCu₁AI or ZnSiCu₁AuAI (green (530 nm)), Y₂SiO₅Tb (green (545 nm)), (Zn,Cd)S:Cu,CI+(Zn,Cd)S:Ag,CI (white), lnBO₃Tb+lnBO₃:Eu (amber), (ZnS:Ag+ZnS:Cu+Y₂O₂S:Eu (white), lnBO₃Tb+lnBO₃:Eu+ZnS:Ag (white), (Ba₁Eu)Mg₂AI₁₆O₂₇ (blue), (Ce₁Tb)MgAI₁₁O₁₉ (green), (Y₁Eu)₂O₃ (red), (Sr,Eu,Ba,Ca)₅(PO₄)CI (blue), (La₁Ce₁Tb)PO₄ (green), Y₂O₃IEu (red (611 nm)), LaPO₄ICe₁Tb (green (544 nm)), (Sr,Ca,Ba)₁₀(PO₄)₆CI₂:Eu (blue (453 nm)), BaMgAI₁₀O₁₇IEu₁Mn (blue-green (456/514 nm)), (La₁Ce₁Tb)PO₄ICe₁Tb (green (546 nm)), Zn₂SiO₄IMn (green (528 nm)), Zn₂SiO₄IMn₁Sb₂O₃ (green (528 nm)), Ce_{06z}Tb_{0 s3}MgAI₁₁O₁₉ICe₁Tb (green (543 nm)), Y₂O₃IEu(III) (red (611 nm)), Mg₄(F)GeO₆IMn ((red (658 nm)), Mg₄(F)(Ge₁Sn)O₆IMn (red (658 nm)), MgWO₄ (pale blue (473 nm)), CaWO₄ (blue (417 nm)), CaWO₄IPb (scheelite, blue (433 nm)), (Ba₁Ti)₂P₂O₇Ti (blue-green (494 nm)), Sr₂P₂O₇ISn, blue (460 nm), Ca₅F(PO₄)₃:Sb (blue (482 nm)), Sr₅F(PO₄)₃:Sb,Mn (blue-green (509 nm)), BaMgAI₁₀O₁₇IEu₁Mn (blue (450 nm)), BaMg₂AI₁₆O₂₇IEu(II) (blue (452 nm)), BaMg₂AI₁₆O₂₇IEu(II)₁Mn(II) (blue (450+515 nm)), Sr₅CI(PO₄)₃:Eu(ll) (blue (447 nm)), Sr₆P₅BO₂₀IEu (blue-green (480 nm)), (Ca₁Zn₁Mg)₃(PO₄J₂ISn (orange-pink (610 nm)), (Sr,Mg)₃(PO₄)₂:Sn (orange-pinkish white (626 nm)), CaSiO₃Pb₁Mn (orange-pink (615 nm),) Ca₅F(PO₄)₃:Sb,Mn (yellow), Ca₅(F,CI)(PO₄)₃:Sb,Mn (warm white to cool white or blue or daylight), (Ca₁Sr₁Ba)₃(PO₄J₂CI₂IEu (blue (452 nm)), 3 Sr₃(PO₄)₂.SrF₂:Sb,Mn (blue (502 nm)), Y(P,V)O₄:Eu (orange-red (619 nm)), (Zn,Sr)₃(PO₄)₂:Mn (orange-red (625 nm)), Y₂O₂SiEu (red (626 nm)), (Sr₁Mg)₃(PO₄)_{Z}iSn(II) (orange-red (630 nm)), 3.5 MgO.0.5 MgF₂.GeO₂ :Mn (red (655 nm)), Mg₅As₂O₁₁)Mn (red (660 nm)), Ca₃(PO₄)₂.CaF₂:Ce,Mn, (yellow (568 nm)), SrAI₂O₇Pb (ultraviolet (313 nm)), BaSi₂O₅)Pb (ultraviolet (355 nm)) SrFB₂O₃:Eu(ll) (ultraviolet (366 nm)), SrB₄O₇:Eu (ultraviolet (368 nm)), MgGa₂O₄)Mn(II), (blue-green), (Ce₁Tb)MgAI₁₁O₁₉ (green), Gd₂O₂SiTb (P43) (green (peak at 545 nm)), Gd₂O₂SiEu (red (627 nm)), Gd₂O₂SiPr (green (513 nm)), Gd₂O₂SiPr₁Ce₁F (green (513 nm)), Y₂O₂SiTb (P45) (white (545 nm)), Y₂O₂SiTb (P22R) (red (627 nm)), Y₂O₂SiTb (white (513 nm)), Zn(0.5)Cd(0.4)S:Ag (HS) (green (560 nm)), Zn(0.4)Cd(0.6)S:Ag (HSr) (red (630 nm)), CdWO₄ (blue (475 nm)), CaWO₄ (blue (410 nm)), MgWO₄ (white (500 nm)), Y₂SiO₅ICe (P47) (blue (400 nm)), YAI0₃:Ce (YAP) (blue (370 nm)), Y₃AI₅O₁₂ICe (YAG) (green (550 nm)), Y₃(AI₁Ga)₅O₁₂ICe (YGG) (green (530 nm)), CdSiIn (green (525 nm)), ZnOiGa (blue (390 nm)), ZnOiZn (P15) (blue (495 nm)), (Zn₁Cd)SiCu₁AI (P22G) (green (565 nm)), ZnSiCu₁AI₁Au (P22G) (green (540 nm)) ZnCdSiAg, Cu (P20) (green (530 nm)), ZnSiAg (P11) (blue (455 nm)), anthracene (blue (447 nm)), plastic (EJ-212, blue (400 nm)), Zn₂SiO₄IMn (P1) (green (530 nm)), ZnSiCu (GS) (green (520 nm)), CsIiTI (green (545 nm)), ⁶LiF/ZnS:Ag (ND) (blue (455 nm)), and ⁶LiF/ZnS:Cu,AI,Au (NDg) (green (565 nm)),
wherein color of light emitted from each phosphor is listed in parenthesis after the phosphor.

4. LED module lighting system according to claim 2, wherein:
at least one LED in a MIO-LED device emits blue light; and
phosphor material is yttrium-aluminum-garnet (YAG) phosphor.

5. LED module lighting system according to claim 1, wherein said DSP is configured to control the power applied to each LED or set of LEDs, such that the colour and brightness of light emitted is the same for each MIO-LED device.

6. LED module lighting system according to claim 1, further comprising a pulse width modulator (PWM) switch for controlling the power applied to each LED or a set of LEDs, using signals from the DSP.

7. LED module lighting system according to claim 6, wherein the DSP is configured to control the PWM switch to adjust the power supplied to two or more LEDs of the same colour present in separate MIO-LED devices, when said two or more LEDs emit different shades of said colour.

8. An LED module lighting system according to claim 1, wherein the DSP is configured to control the DAC to adjust the power supplied to two or more LEDs of the same colour present in separate MIO-LED devices, when said two or more LEDs emit different shades of said colour.

9. An LED module lighting system according to claim 8, wherein said two or more LEDs of the same colour have not been grouped by binning.

10. LED module lighting system according to claim 1, further comprising one or more temperature sensors configured to provide temperature information of the module lighting system to the DSP.

11. LED module lighting system according to claim 10, wherein the DSP is configured to control of the power applied to each LED or set of LEDs of an MIO-LED device based on temperature information received from the temperature sensors, such that the colour and brightness of light emitted from each MIO-LED device is maintained where there are changes in temperature.

12. LED module lighting system according to claim 1, further comprising one or more air cooling fan, configured to cool at least some of the LEDs.

13. LED module lighting system according to claim 12, wherein said DSP is configured to control power to the fan based on temperature information received from the temperature sensors.

14. LED module lighting system according to claim 13, wherein the DSP is configured, such that the colour and brightness of light emitted from each MIO-LED device is maintained where there are changes in temperature.

15. LED module lighting system according to claim 1, further comprising one or more network interfaces configured to signals to the DSP, allowing an external control.

16. LED module lighting system according to claim 1, further comprising one or more IR sensors configured provide to signals to the DSP, allowing an external control.

17. LED module lighting system according to claim 1, further comprising a power supply configured to supply power to the LEDs and other components.

18. LED module lighting system according to claim 17, wherein said power supply has a plurality of DC voltage outputs, each providing a different voltage to match the rating voltage for a colour-emitting LED.

19. LED module lighting system according to claim 17, wherein said power supply is configured to adapt output level, for at least one colour dependent, on the required light output, controlled by the DSP.

20. LED module lighting system according to claim 17, further comprising a secondary induction coupler, which provides power to the power supply by electromagnetic induction from a primary induction coupler.

21. LED module lighting system according to claim 1, further comprising a memory storage device configured to provide data to the DSP regarding colour and/or brightness compensation information of each MIO-LED device.

22. LED module lighting system according to claim 1, wherein the DSP is configured to continuously monitor the power supplied to each LED in order to maintain the colour and brightness provided by each MIO-LED device.

23. LED module lighting system according to claim 22, wherein the colour and brightness are maintained according to relationships between current and colour behavior, and/or light output vs. temperature data.

24. LED module lighting system according to claim 23, wherein said relationships are stored as data within storage device where present.

25. LED module lighting system according to claim 1, wherein the colour temperature, CT, of the emitted light is adjustable.

26. LED module lighting system according to claim 1, capable of emitting light that provides a high colour rendition index, CRI.

27. Modular LED device comprising a housing and one or more LED module systems according to claim 1, whereby:
an array of MIO-LED devices is arranged as a light emitting surface, and
a mechanical means to stack two or more modular LED devices is provided.

28. Modular LED device according to claim 27, whereby said mechanical stacking means aligns the respective light emitting surfaces to project light towards the same direction.

29. Modular LED device according to claim 28, wherein the housing comprises an interfacing material which can be used to make contact with other heat conductive materials, so as to transfer heat from the device more easily.
